(19) United States
(12) Patent Application Publication
(10) Pub. No.: US 2025/0380327 A1
(43) Pub. Date: Dec. 11, 2025

(54) DYNAMIC SINGLE TRP SWITCHING IN MULTI-TRP OPERATION

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/876,153

(22) PCT Filed: Jul. 18, 2022
(86) PCT No.: PCT/CN2022/106175

§ 371 Date: Dec. 17, 2024

(51) Int. Cl. H04W 76/20; H04W 16/28; H04W 72/0446; H04W 72/1268; H04W 72/231

(52) U.S. Cl. CPC H04W 76/20; H04W 16/28; H04W 72/0446; H04W 72/1268; H04W 72/231

(57) ABSTRACT

A network entity may communicate at least one first transmission with a user equipment (UE) via a first transmission-reception point (TRP) and a second TRP in a multi-TRP (mTRP). The network entity may transmit an indication to switch to a single TRP (sTRP) mode to the UE, or a condition of the UE, such as a configured specification, may provide the indication to switch to the sTRP mode. The UE may obtain the indication to switch to the sTRP mode from the network entity or from the condition. The UE may switch to communicate at least one second transmission with the network node via one of the first TRP or the second TRP in the sTRP mode based on the indication to switch to the sTRP mode.

### TECHNICAL FIELD

The present disclosure relates generally to communication systems, and more particularly, to a system with multiple transmission-reception points (mTRPs).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may have a memory and at least one processor coupled to the memory UE. Based at least in part on information stored in the memory, the at least one processor may be configured to communicate at least one first transmission with a network node via a first transmission-reception point (TRP) and a second TRP in a multiple TRP (mTRP) mode. Based at least in part on information stored in the memory, the at least one processor may be configured to obtain an indication to switch to a single TRP (sTRP) mode. Based at least in part on information stored in the memory, the at least one processor may be configured to switch to communicate at least one second transmission with the network node via one of the first TRP or the second TRP in the sTRP mode based on the indication to switch to the sTRP mode.

In an aspect of the disclosure, a method, a computer-readable medium, and an apparatus are provided. The apparatus may have a memory and at least one processor coupled to the memory network node. Based at least in part on information stored in the memory, the at least one processor may be configured to communicate at least one first transmission with a user equipment (UE) via a first transmission-reception point (TRP) and a second TRP in a multi-TRP (mTRP) mode. Based at least in part on information stored in the memory, the at least one processor may be configured to transmit an indication to switch to a single TRP (sTRP) mode to the UE. Based at least in part on information stored in the memory, the at least one processor may be configured to switch to communicate at least one second transmission with the UE via one of the first TRP or the second TRP in the sTRP mode based on the indication to switch to the sTRP mode.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram having a UE configured to communicate with multiple TRPs in a cell group.

FIG. 5A is a diagram illustrating an example of an mTRP resource configuration, in accordance with various aspects of the present disclosure.

FIG. 5B is a diagram illustrating an example of an mTRP resource configuration, in accordance with various aspects of the present disclosure.

FIG. 5C is a diagram illustrating an example of an mTRP resource configuration, in accordance with various aspects of the present disclosure.

FIG. 5D is a diagram illustrating an example of an mTRP resource configuration, in accordance with various aspects of the present disclosure.

FIG. 5E is a diagram illustrating an example of an mTRP resource configuration, in accordance with various aspects of the present disclosure.

FIG. 5F is a diagram illustrating an example of an mTRP resource configuration, in accordance with various aspects of the present disclosure.

FIG. 6 is a diagram illustrating an example of scheduling DCI, in accordance with various aspects of the present disclosure.

FIG. 7 is a connection flow diagram illustrating a UE configured to communicate with multiple TRPs in a cell group.

FIG. 8 is a connection flow diagram illustrating a UE configured to communicate with multiple TRPs in a cell group.

FIG. 9 is a connection flow diagram illustrating a UE configured to communicate with multiple TRPs in a cell group.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a flowchart of a method of wireless communication.

FIG. 16 is a flowchart of a method of wireless communication.

FIG. 17 is a flowchart of a method of wireless communication.

FIG. 18 is a flowchart of a method of wireless communication.

FIG. 19 is a diagram illustrating an example of a hardware implementation for an example apparatus and/or network entity.

FIG. 20 is a diagram illustrating an example of a hardware implementation for an example network entity.

FIG. 21 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission-reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

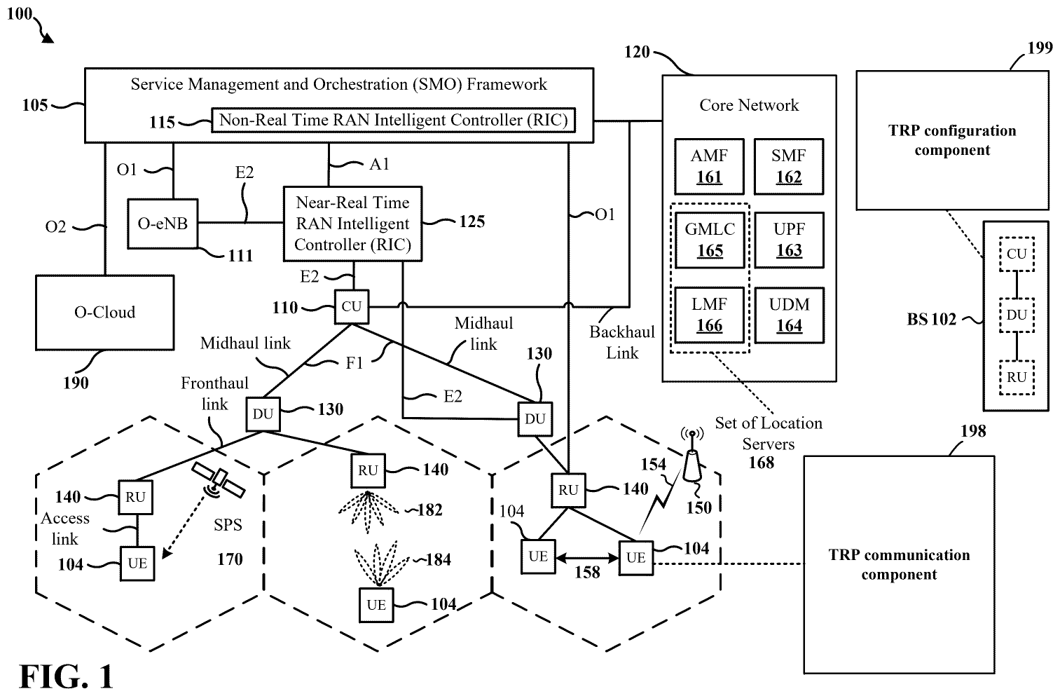

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an El interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmission-reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a TRP communication component 198 configured to communicate at least one first transmission with a network node via a first TRP and a second TRP in an mTRP mode. The TRP communication component 198 may be configured to obtain an indication to switch to an sTRP mode. The TRP communication component 198 may be configured to switch to communicate at least one second transmission with the network node via one of the first TRP or the second TRP in the sTRP mode based on the indication to switch to the sTRP mode. In certain aspects, the base station 102 may have a TRP configuration component 199 configured to communicate at least one first transmission with a UE via a first TRP and a second TRP in an mTRP mode. The TRP configuration component 199 may be configured to transmit an indication to switch to an sTRP mode to the UE. The TRP configuration component 199 may be configured to switch to communicate at least one second transmission with the UE via one of the first TRP or the second TRP in the sTRP mode based on the indication to switch to the sTRP mode. Although the following description may be focused on 5G NR, the concepts described herein may be applicable to other similar areas, such as LTE, LTE-A, CDMA, GSM, and other wireless technologies.

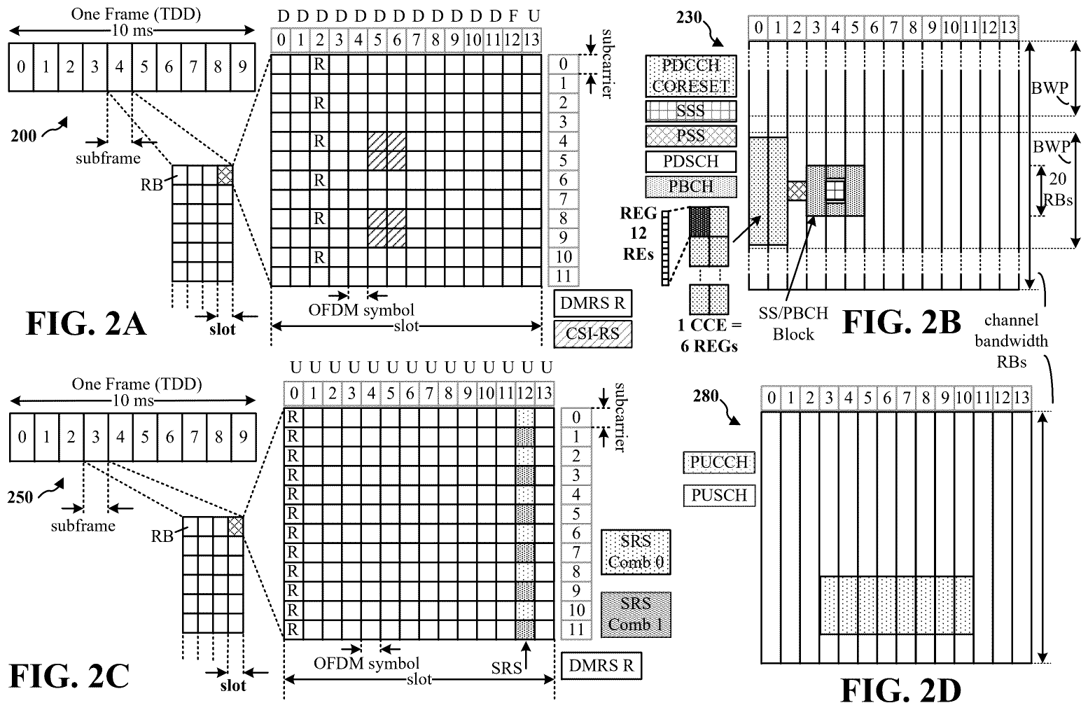

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

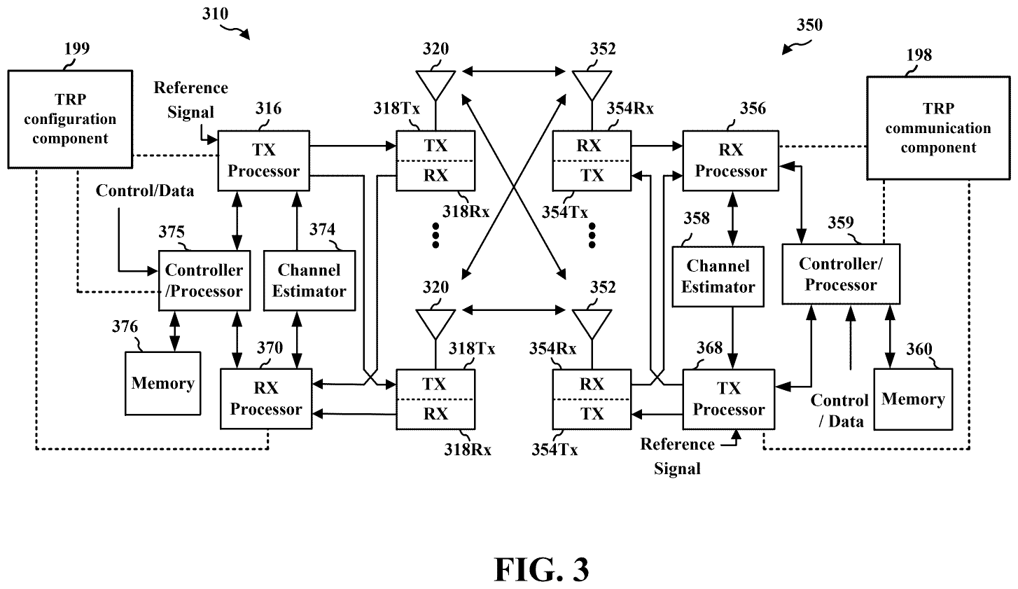

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the TRP communication component 198 of FIG. 1.

At least one of the TX processor 316, the RX processor 370, and the controller/processor 375 may be configured to perform aspects in connection with the TRP configuration component 199 of FIG. 1.

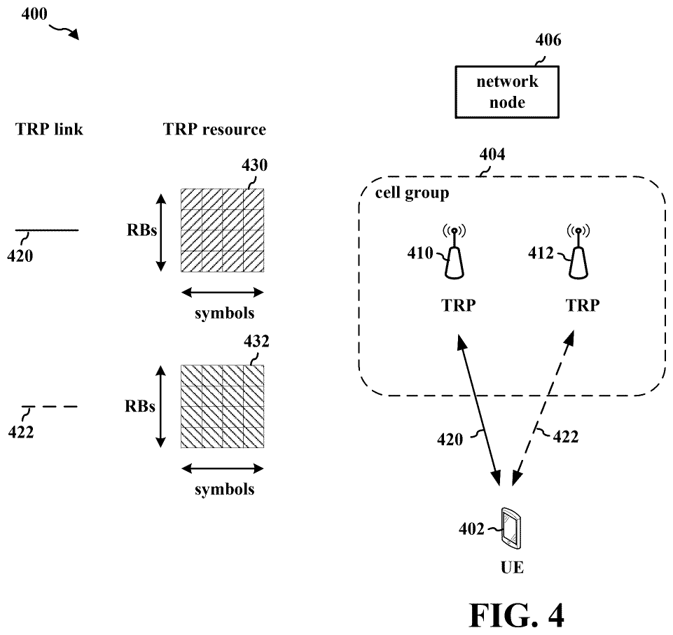

A network node may be configured to communicate with a UE via one or more TRPs in a cell or a zone. FIG. 4 shows a diagram 400 having a UE 402 configured to communicate with a network node 406. The network node 406 may be a single network entity, a plurality of network entities (multiple network entities controlling a set of TRPs), or a plurality of different network entities (each network entity controlling a different TRP) in network communication with one another, such as via backhaul connection. The network node 406 may be, for example, the CU 110 or the DU 130 in FIG. 1. The network node 406 may be in network communication with the TRP 410 or TRP 412, such as via backhaul connection. The TRP 410 or the TRP 412 may each include a transceiver configured to communicate with a common UE, such as the UE 402. Each of the TRP 410 or the TRP 412 may be, for example, the RU 140 or a panel of the base station 102 in FIG. 1. The TRP 410 and the TRP 412 may form a cell group 404. Each of the TRP 410 and the TRP 412 may be controlled and operated by the network node 406. While the cell group 404 is shown as having two TRPs, a cell group may have more or less TRPs in other aspects. TRP 410 and TRP 412 may each be designated as part of the same quasi co-located (QCL) group. Each of the TRP 410 and TRP 412 may be active simultaneously, providing maximum throughput in times of a high load.

The UE 402 may be configured to communicate with the TRP 410 via a communication link 420. The UE 402 may be configured to communicate with the TRP 412 via a communication link 422. The communication link may be a wireless communication link using a frame structure, such as the frame structures illustrated in FIGS. 2A-2D. The network node 406 may allocate TRP resources 430 to the communication link 420 between the TRP 410 and the UE 402. The TRP resources 430 may be defined as a set of RBs and a set of symbols. The network node may allocate TRP resources 432 to the communication link 422 between the TRP 412 and the UE 402. The TRP resources 432 may be defined as a set of RBs and a set of symbols.

The UE 402 may be configured to communicate with the network node 406 via the TRP 410 and the TRP 412 using any suitable channel. For example, the UE 402 may be configured to communicate with the network node 406 via the TRP 410 and the TRP 412 using PDCCH, PDSCH, PUSCH, and/or PUCCH. Communications between the UE 402 and the network node 406 may have an increased throughput if the UE 402 communicates via both the TRP 410 and the TRP 412 verses if the UE 402 communicates via one of either the TRP 410 or the TRP 412. In some aspects, it may be advantageous for the UE 402 to communicate with the network node 406 via one of either the TRP 410 or the TRP 412, for example to increase a signal to noise ratio (SNR) or to decrease power consumption. In some aspects, the network node 406 may be configured to switch communication with the UE 402 from an mTRP mode to an sTRP mode. In some aspects, the network node 406 may be configured to switch communication with the UE 402 from an mTRP mode to an sTRP mode for one transmission, and may then switch communication with the UE 402 back to the mTRP mode after the one transmission.

The network node 406 may be configured to communicate at least one first transmission with the UE 402 via the TRP 410 and the TRP 412 in an mTRP mode. The UE 402 may be configured to communicate at least one first transmission with the network node 406 via the TRP 410 and the TRP 412 in the mTRP mode. The network node 406 may be configured to transmit an indication to switch to an sTRP mode to the UE 402. The UE 402 may be configured to obtain the indication to switch to an sTRP mode from the network node 406. The network node 406 may be configured to switch to communicate at least one second transmission with the UE 402 via one of the TRP 410 or the TRP 412 in the sTRP mode based on the indication to switch to the sTRP mode. The UE 402 may be configured to switch to communicate at least one second transmission with the network node 406 via one of the TRP 410 or the TRP 412 in the sTRP mode based on the indication to switch to the sTRP mode.

By enabling the network node 406 to support switching its communication mode with the UE 402 between an mTRP mode and an sTRP mode, the network node 406 may utilize mTRP mode advantages in some aspects, such as the increased throughput or reliability of communications with the UE 402, and may utilize sTRP mode advantages in other aspects, such as decreased power consumption or noise during communications with the UE 402.

An mTRP system may have one or more transmission configuration indicators (TCIs). A TCI may be used to indicate a beam for a TRP, for example a first TCI may indicate a PDCCH beam for the TRP 410, a second TCI may indicate a PDSCH beam for the TRP 410, a third TCI may indicate a PUCCH beam for the TRP 410, a fourth TCI may indicate a PUSCH beam for the TRP 410, a fifth TCI may indicate a PDCCH beam for the TRP 412, a sixth TCI may indicate a PDSCH beam for the TRP 412, a seventh TCI may indicate a PUCCH beam for the TRP 412, and an eighth TCI may indicate a PUSCH beam for the TRP 412. While an mTRP system may have a TCI for each beam of each TRP, it may be more efficient to use unified TCIs that are able to indicate a common beam between two or more beams of a TRP, such as a PDCCH and a PUCCH of the TRP 410, or to indicate a common beam between two or more beams of a plurality of TRPs, such as a PUCCH of the TRP 410 and a PUCCH of the TRP 412.

In one aspect, a joint TCI state may indicate a common beam for at least one DL channel or reference signal (RS) plus at least one UL channel or RS. The joint TCI state may be specific to one UE, such as the UE 402 in FIG. 4, and may be common to two or more TRPs, such as the TRP 410 and the TRP 412. A joint TCI state may indicate a common beam for a PDCCH and/or PDSCH plus PUCCH and/or PUSCH. In one aspect, a separate DL TCI state may indicate a common beam for at least two DL channels or RSs. A separate DL TCI state may indicate a common beam for a UE-specific PDCCH plus PDSCH. In one aspect, a separate UL TCI state may indicate a common beam for at least two UL channels or RSs. A separate UL TCI state may indicate a common beam for a UE-specific PUCCH plus PUSCH. A network node, such as the network node 406 in FIG. 4, may configure joint or separate TCI states via RRC configuration.

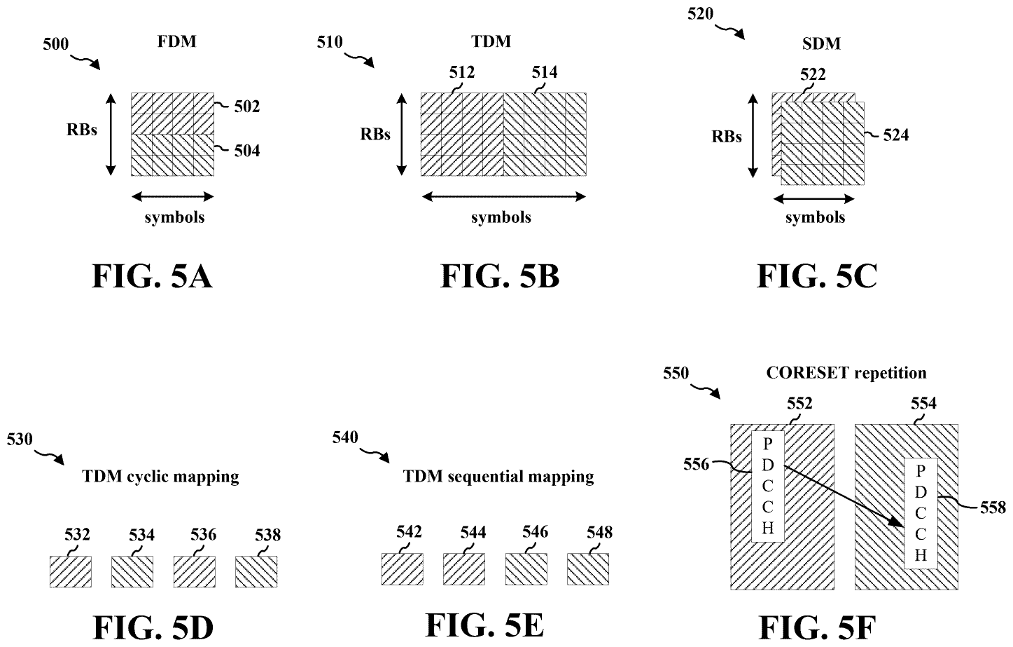

FIGS. 5A-5F illustrate various examples of mTRP resource allocation configurations for a UE configured to communicate with a plurality of TRPs in a cell group. FIG. 5A is a diagram 500 illustrating an example of an mTRP resource allocation configuration. A network node may use frequency division multiplexing (FDM) to configure a UE to have a set of resources 502 for a first TRP and a set of resources 504 for a second TRP. The set of resources 502 may have RBs different than the set of resources 504. The set of resources 502 associated with the first TRP may have a frequency that is adjacent to a frequency of the set of resources 504 associated with the second TRP.

FIG. 5B is a diagram 510 illustrating an example of an mTRP resource allocation configuration. A network node may use time division multiplexing (TDM) to configure a UE to have a set of resources 512 for a first TRP, such as the TRP 410 in FIG. 4, and a set of resources 514 for a second TRP, such as the TRP 412 in FIG. 4. The set of resources 512 may have different symbols than the set of resources 514. The set of resources 512 associated with the first TRP may have resources that directly precede or directly follow the set of resources 514 associated with the second TRP.

The diagram 510 may represent a repetition of a transmission using a first TRP and a second TRP. For example, the diagram 510 may represent a first PUCCH associated with a first TRP associated with the set of resources 512 and a second PUCCH associated with a second TRP associated with the set of resources 514.

FIG. 5C is a diagram 520 illustrating an example of an mTRP resource allocation configuration. A network node may use spatial division multiplexing (SDM) to configure a UE to have a set of resources 522 for a first TRP, such as the TRP 410 in FIG. 4, and a set of resources 524 for a second TRP, such as the TRP 412 in FIG. 4. The set of resources 522 may be transmitted through a different spatial area than the set of resources 524. The set of resources 522 associated with the first TRP may have resources that spatially juxtapose with the set of resources 524 associated with the second TRP.

FIG. 5D is a diagram 530 illustrating an example of an mTRP resource allocation configuration. A network node may use TDM cyclic mapping to configure a UE to cyclically or periodically have a set of resources including the resources 532 and the resources 536 for a first TRP, such as the TRP 410 in FIG. 4, and cyclically or periodically have a set of resources including the resources 534 and the resources 538 for a second TRP, such as the TRP 412 in FIG. 4. The resources 532 and 536 may be associated with the first TRP and the resources 534 and 538 may be associated with the second TRP. The resources 532 and 536 may be cyclically mapped to the first TRP and the resources 534 and 538 may be cyclically mapped to the second TRP. A network node or a UE may use RRC configuration to cyclically map sets of resources to the first TRP and to the second TRP in TDM.

FIG. 5E is a diagram 540 illustrating an example of an mTRP resource allocation configuration. A network node may use TDM sequential mapping to configure a UE to have a set of resources including the resources 542 and the resources 544 for a first TRP, such as the TRP 410 in FIG. 4, which are contiguous before or after a set of resources including the resources 546 and 548 for a second TRP, such as the TRP 412 in FIG. 4. The resources 542 and 544 may be associated with the first TRP and the resources 546 and 548 may be associated with the second TRP. The resources 542 and 544 may be sequentially mapped to the first TRP and the resources 546 and 548 may be sequentially mapped to the second TRP. A network node or a UE may use RRC configuration to sequentially map sets of resources to the first TRP and to the second TRP in TDM.

FIG. 5F is a diagram 550 illustrating an example of an mTRP resource allocation configuration. A network node may use CORESET repetition to configure a UE to have a CORESET 552 associated with a first TRP, such as the TRP 410 in FIG. 4, and a CORESET 554 associated with a second TRP, such as the TRP 412 in FIG. 4. The CORESET 552 may be associated with the first TRP and the CORESET 554 may be associated with the second TRP. A PDCCH 556 associated with the CORESET 552 and a PDCCH 558 associated with the CORESET 554 may be linked to enable a PDCCH repetition. In other words, the PDCCH 556 of CORESET 552 transmitted to a UE may be repeated via the PDCCH 558 of CORESET 554.

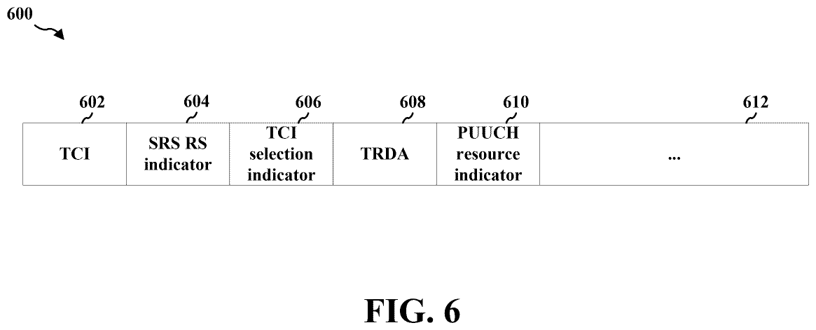

FIG. 6 shows an example of a scheduling DCI 600 having a TCI field 602, an SRS resource set indicator field 604, a TCI selection indicator field 606, a time domain resource allocation (TDRA) field 608, a PUUCH resource indicator 610, and other fields 612 that are not explicitly shown in the diagram 600. The scheduling DCI 600 may be used to indicate use of an sTRP mode for a scheduled transmission. The scheduling DCI 600 may be used to indicate use of an mTRP mode for a scheduled transmission. One or more of the fields of the scheduling DCI 600 may be dedicated to indicate to a receiving UE, such as the UE 402 in FIG. 4, use of an sTRP mode for a scheduled transmission. One or more of the fields of the scheduling DCI 600 may have a portion (e.g., one or more bits) that indicates to a receiving UE, such as the UE 402 in FIG. 4, use of an sTRP mode for a scheduled transmission. One or more of the fields of the scheduling DCI 600 may be dedicated to indicate to a receiving UE, such as the UE 402 in FIG. 4, use of an mTRP mode for a scheduled transmission. One or more of the fields of the scheduling DCI 600 may have a portion (e.g., one or more bits) that indicate to a receiving UE, such as the UE 402 in FIG. 4, use of an mTRP mode for a scheduled transmission.

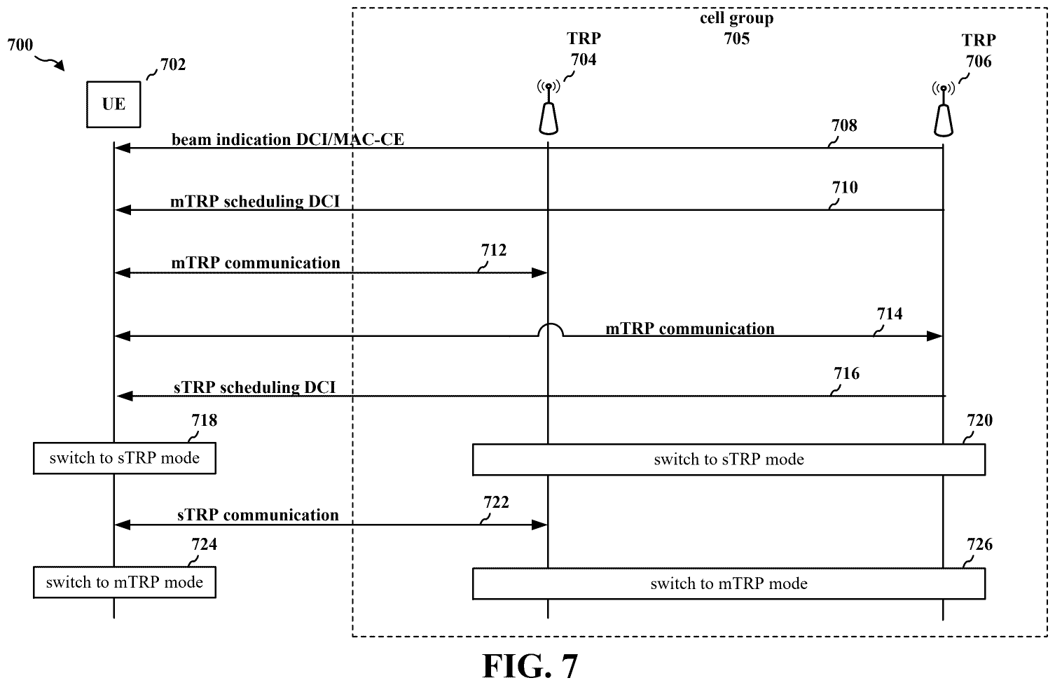

FIG. 7 shows a connection flow diagram 700 illustrating a UE 702 configured to communicate with a TRP 704 and a TRP 706 in a cell group 705. The cell group 705 may be controlled and operated by a network node, such as the base station 102 in FIG. 1 or the network node 406 in FIG. 4.

The TRP 704 or the TRP 706 may transmit a beam indication DCI or a beam indication MAC-CE 708 to the UE 702. The UE 702 may receive the beam indication DCI or a beam indication MAC-CE 708 from the TRP 704 or the TRP 706. The beam indication DCI or a beam indication MAC-CE 708 may indicate an mTRP operation using a pair of unified TCIs. The pair of unified TCIs may each identify two DL applicable TCIs or two UL applicable TCIs for each of the TRP 704 and the TRP 706. For example, a first TCI may be associated with a PDSCH and a PDCCH of the TRP 704 and a second TCI may be associated with a PDSCH and a PDCCH of the TRP 706. In another aspect, a first TCI may be associated with a PDSCH and a PUSCH of the TRP 704 and a second TCI may be associated with a PDSCH and a PUSCH of the TRP 706.

The TRP 704 or the TRP 706 may transmit an mTRP scheduling DCI 710 to the UE 702. The UE 702 may receive the mTRP scheduling DCI 710 from the TRP 704 or the TRP 706. The mTRP scheduling DCI 710 may indicate an mTRP communication using the pair of unified TCIs indicated by the beam indication DCI or a beam indication MAC-CE 708. The mTRP communication may be, for example, a PDSCH communication with both the TRP 704 and the TRP 706, or a PUSCH communication with both the TRP 704 and the TRP 706. The TRP 704 may communicate with the UE 702 via mTRP communication 712 in response to the mTRP scheduling DCI 710, which may be a PDSCH or a PUSCH. The TRP 706 may communicate with the UE 702 via mTRP communication 714 in response to the mTRP scheduling DCI 710, which may be a PDSCH or a PUSCH.

The TRP 704 or the TRP 706 may transmit an sTRP scheduling DCI 716 to the UE 702. The UE 702 may receive the sTRP scheduling DCI 716 from the TRP 704 or the TRP 706. The sTRP scheduling DCI 716 may indicate an sTRP communication 722 using a field of the scheduling DCI 716. The sTRP scheduling DCI 716 may select a TCI state corresponding to the TRP 704 or the TRP 706. While the connection flow diagram 700 shows that the sTRP scheduling DCI 716 indicates a selection of a TCI state associated with the TRP 704, in other aspects, the sTRP scheduling DCI 716 may indicate a selection of a TCI state associated with the TRP 706.

In one aspect, a dedicated field of the sTRP scheduling DCI 716 may indicate to the UE 702 which indicated TCI state applies to the PDSCH or PUSCH of the sTRP communication 722. In one aspect, if the sTRP communication 722 is a PUSCH transmission, the dedicated field may be the SRS resource set indicator field 604 in FIG. 6. In one aspect, if the sTRP communication 722 is a PDSCH transmission, the dedicated field may be the TCI selection indicator field 606 in FIG. 6. In response to the dedicated field including the selected TCI state associated with the TRP 704, at 718 the UE 702 may switch to communicating with the TRP 704 in sTRP mode via the sTRP communication 722. At 720, the TRP 704 may switch to communicating with the UE 702 in sTRP mode via the sTRP communication 722. At 720, the TRP 706 may switch to not communicating with the UE 702.

In one aspect, a TDRA field of the sTRP scheduling DCI 716 may indicate to the UE 702 which indicated TCI state applies to the PDSCH or PUSCH of the sTRP communication 722. The TDRA field may be, for example, the TDRA field 608 in FIG. 6. In one aspect, the TDRA field may indicate at least one of a slot offset value (e.g., K0), a start and length indicator value (SLIV), or a TCI selection indicator to the scheduled PDSCH or PUSCH. The TCI selection indicator may select the TCI state associated with the TRP 704 or the TRP 706 for the scheduled PDSCH or PUSCH. If the TCI selection indicator does not select a TRP (e.g., has a zero or null value), the UE 702 may apply both TCIs for the scheduled PDSCH or PUSCH (i.e., performs mTRP communication with both the TRP 704 and the TRP 706). For example, the mTRP scheduling DCI 710 may include a TDRA field having a TCI selection indicator that does not select a TRP. In response to the TCI selection indicator including the selected TCI state associated with the TRP 704, at 718 the UE 702 may switch to communicating with the TRP 704 in sTRP mode via the sTRP communication 722. At 720, the TRP 704 may switch to communicating with the UE 702 in sTRP mode via the sTRP communication 722. At 720, the TRP 706 may switch to not communicating with the UE 702.

In one aspect, a TCI field of the sTRP scheduling DCI 716 may indicate to the UE 702 which indicated TCI state applies to the PDSCH or PUSCH of the sTRP communication 722. TCI field may include a dedicated bit that selects a TCI. For example, the TCI field may have three bits to indicate an index of a TCI state (e.g., for example selected from a table provided by RRC configuration), and may have a dedicated bit that select a TCI from a first TCI associated with the TRP 704 and a second TCI associated with the TRP 706. In one aspect, one or more TCI codepoints in the sTRP scheduling DCI 716 may indicate to the UE 702 a selected TCI which indicated TCI state applies to the PDSCH or PUSCH of the sTRP communication 722. In response to the TCI field of the sTRP scheduling DCI 716 including the selected TCI state associated with the TRP 704, at 718 the UE 702 may switch to communicating with the TRP 704 in sTRP mode via the sTRP communication 722. At 720, the TRP 704 may switch to communicating with the UE 702 in sTRP mode via the sTRP communication 722. At 720, the TRP 706 may switch to not communicating with the UE 702.

At 724, the UE 702 may switch back to the mTRP mode. The UE 702 may switch back to the mTRP mode in response to completing the sTRP communication 722 (e.g., upon completion of a PUSCH transmission or upon transmitting an ACK from the TRP 704 for a PDSCH transmission). At 726, the TRP 704 may switch to communicating with the UE 702 in mTRP mode. At 726, the TRP 706 may switch to communicating with the UE 702 in mTRP mode.

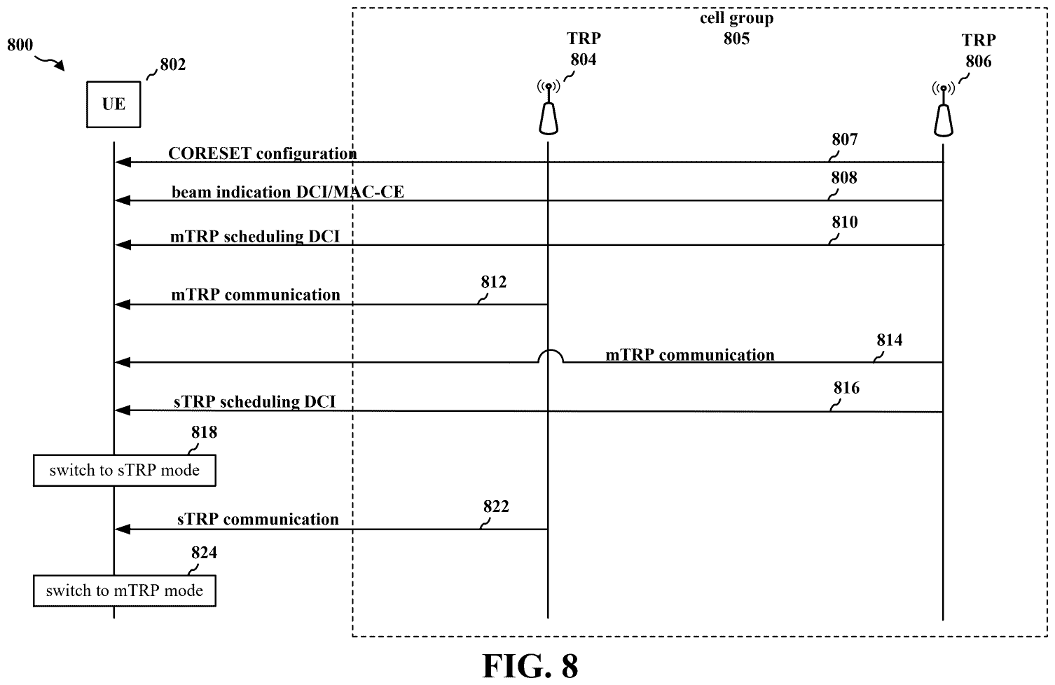

FIG. 8 shows a connection flow diagram 800 illustrating a UE 802 configured to communicate with a TRP 804 and a TRP 806 in a cell group 805. The cell group 805 may be controlled and operated by a network node, such as the base station 102 in FIG. 1 or the network node 406 in FIG. 4.

The TRP 804 or the TRP 806 may transmit a CORESET configuration 807 to the UE 802. The UE 802 may receive the CORESET configuration 807 from the TRP 804 or the TRP 806. The CORESET configuration 807 may be, for example, an RRC configuration that configures one or more CORESETs associated with the UE 802. In one aspect, the CORESET configuration 807 may configure two CORESETs to enable a PDCCH repetition, such as the PDCCH repetition illustrated by diagram 550 in FIG. 5F.

The TRP 804 or the TRP 806 may transmit a beam indication DCI or a beam indication MAC-CE 808 to the UE 802. The UE 802 may receive the beam indication DCI or a beam indication MAC-CE 808 from the TRP 804 or the TRP 806. The beam indication DCI or a beam indication MAC-CE 808 may indicate an mTRP operation using a pair of unified TCIs. The pair of unified TCIs may each identify two DL applicable TCIs or two UL applicable TCIs for each of the TRP 804 and the TRP 806. For example, a first TCI may be associated with a PDSCH and a PDCCH of the TRP 804 and a second TCI may be associated with a PDSCH and a PDCCH of the TRP 806. In another aspect, a first TCI may be associated with a PDCCH and a PUCCH of the TRP 804 and a second TCI may be associated with a PDCCH and a PUCCH of the TRP 806.

The TRP 804 or the TRP 806 may transmit an mTRP scheduling DCI 810 to the UE 802. The UE 802 may receive the mTRP scheduling DCI 810 from the TRP 804 or the TRP 806. The mTRP scheduling DCI 810 may indicate an mTRP communication using the pair of unified TCIs indicated by the beam indication DCI or a beam indication MAC-CE 808. The mTRP communication may be, for example, a repeated PDCCH communication with both the TRP 804 and the TRP 806 using a CORESET repetition. The TRP 804 may communicate with the UE 802 via mTRP communication 812 in response to the mTRP scheduling DCI 810, which may be a PDCCH repeated using CORESET repetition. The TRP 806 may communicate with the UE 802 via mTRP communication 814 in response to the mTRP scheduling DCI 810, which may be a PDCCH repeated using CORESET repetition.

The TRP 804 or the TRP 806 may transmit an sTRP scheduling DCI 816 to the UE 802. The UE 802 may receive the sTRP scheduling DCI 816 from the TRP 804 or the TRP 806. The sTRP scheduling DCI 816 may indicate an sTRP communication 822 using a field of the scheduling DCI 816. The sTRP scheduling DCI 816 may select an unsuitable TCI state for the sTRP communication 822. At 818, in response to the sTRP scheduling DCI 816 selecting an unsuitable TCI state associated with the TRP 806 for the sTRP communication 822, the UE 802 may refrain from monitoring PDCCH candidates associated with the TRP 806 (i.e., associated with the unsuitable TCI state). The UE 802 may be configured to refrain from, or skip, monitoring the PDCCH candidates after a number of symbols from sending an ACK to the sTRP scheduling DCI 816. While the connection flow diagram 800 shows that the sTRP scheduling DCI 816 indicates a selection of an unsuitable TCI state associated with the TRP 806, in other aspects, the sTRP scheduling DCI 816 may indicate a selection of an unsuitable TCI state associated with the TRP 804.

In one aspect, a dedicated field of the sTRP scheduling DCI 816 may indicate to the UE 802 which unsuitable TCI state applies to skipping the PDCCH repetition of the sTRP communication 822. In one aspect, the dedicated field may be the SRS resource set indicator field 604 in FIG. 6. In one aspect, the dedicated field may be the TCI selection indicator field 606 in FIG. 6. In response to the dedicated field including the unsuitable TCI state associated with the TRP 806, at 818 the UE 802 may switch to communicating with the TRP 804 in sTRP mode via the sTRP communication 822 by refraining from monitoring PDCCH candidates associated with the unsuitable TCI state (i.e., associated with the TRP 806).

In one aspect, a TDRA field of the sTRP scheduling DCI 816 may indicate to the UE 802 which unsuitable TCI state applies to the PDCCH of the sTRP communication 822. The TDRA field may be, for example, the TDRA field 608 in FIG. 6. In one aspect, the TDRA field may indicate at least one of a slot offset value (e.g., K0), a start and length indicator value (SLIV), or a TCI selection indicator to the scheduled PDCCH. The TCI selection indicator may select the unsuitable TCI state associated with the TRP 804 or the TRP 806 for the scheduled PDCCH. If the TCI selection indicator does not select a TRP (e.g., has a zero or null value), the UE 802 may monitor both PDCCH candidates associated with the CORESET repetition for the scheduled PDCCH (i.e., performs mTRP communication with both the TRP 804 and the TRP 806). For example, the mTRP scheduling DCI 810 may include a TDRA field having a TCI selection indicator that does not select a TRP. In response to the TCI selection indicator including the unsuitable TCI state associated with the TRP 806, at 818 the UE 802 may refrain from monitoring the PDCCH candidates associated with the unsuitable TCI state (i.e., associated with the TRP 806) for the sTRP communication 822.

At 824, the UE 802 may switch back to the mTRP mode. The UE 802 may switch back to the mTRP mode in response to completing the sTRP communication 822 (e.g., upon transmitting an ACK for the PDCCH transmission). Switching back to the mTRP mode may include monitoring both PDCCH candidates associated with a CORESET repetition.

In one aspect, the beam indication DCI or the beam indication MAC-CE 808 may indicate an mTRP operation using a single unified TCI associated with both of the TRP 804 and the TRP 806. For example, the beam indication DCI or the beam indication MAC-CE 808 may define a first single unified TCI associated with PDCCH for both the TRP 804 and the TRP 806, and a second single unified TCI associated with PDCCH for the TRP 804 and not the TRP 806. In other words, the first single unified TCI may be for receiving the two linked CORESETs in FIG. 5F, and the second single unified TCI may be for receiving one of the two linked CORESETs in FIG. 5F. In one aspect, the second single unified TCI may be predetermined by a TCI to CORESET association. In one aspect, the second single unified TCI may be preconfigured or predetermined by a condition, such as a definition in a specification. For example, the condition may be to select a lower CORESET ID for a TCI state, or to select a higher CORESET ID for a TCI state.

The TRP 804 or the TRP 806 may transmit an mTRP scheduling DCI 810 to the UE 802. The UE 802 may receive the mTRP scheduling DCI 810 from the TRP 804 or the TRP 806. The mTRP scheduling DCI 810 may indicate an mTRP communication using the single unified TCI indicated by the beam indication DCI or a beam indication MAC-CE 808 that is associated with the TRP 804 and the TRP 806. The mTRP communication may be, for example, a repeated PDCCH communication with both the TRP 804 and the TRP 806 using a CORESET repetition. The TRP 804 may communicate with the UE 802 via mTRP communication 812 in response to the mTRP scheduling DCI 810, which may be a PDCCH repeated using CORESET repetition. The TRP 806 may communicate with the UE 802 via mTRP communication 814 in response to the mTRP scheduling DCI 810, which may be a PDCCH repeated using CORESET repetition.

The TRP 804 or the TRP 806 may transmit an sTRP scheduling DCI 816 to the UE 802. The UE 802 may receive the sTRP scheduling DCI 816 from the TRP 804 or the TRP 806. The sTRP scheduling DCI 816 may indicate a single unified TCI for receiving one of the two linked CORESETs. In other words, the sTRP scheduling DCI 816 may indicate a TCI state associated with the TRP 804 and not associated with the TRP 806. The UE 802 may be configured to refrain from, or skip, monitoring the PDCCH candidates after a number of symbols from sending an ACK to the sTRP scheduling DCI 816. While the connection flow diagram 800 shows that the sTRP scheduling DCI 816 indicates a single unified TCI associated with the TRP 804 and not associated with the TRP 806, in other aspects, the sTRP scheduling DCI 816 may indicate a selection of a single unified TCI associated with the TRP 806 and not associated with the TRP 804. In response to the sTRP scheduling DCI 816 indicating a single unified TCI for receiving the CORESET associated with the TRP 804, at 818 the UE 802 may refrain from monitoring the PDCCH candidates associated with the TRP 806 for the sTRP communication 822.

At 824, the UE 802 may switch back to the mTRP mode. The UE 802 may switch back to the mTRP mode in response to completing the sTRP communication 822 (e.g., upon transmitting an ACK for the PDCCH transmission). Switching back to the mTRP mode may include monitoring both PDCCH candidates associated with a CORESET repetition.

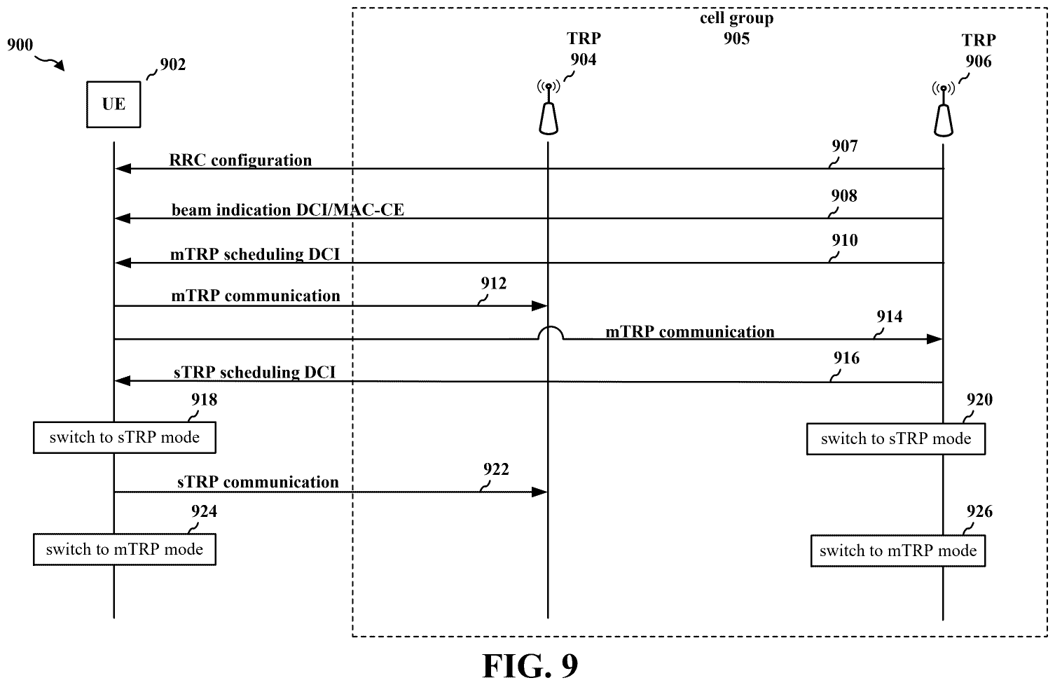

FIG. 9 shows a connection flow diagram 900 illustrating a UE 902 configured to communicate with a TRP 904 and a TRP 906 in a cell group 905. The cell group 905 may be controlled and operated by a network node, such as the base station 102 in FIG. 1 or the network node 406 in FIG. 4.

The TRP 904 or the TRP 906 may output an RRC configuration 907 to the UE 902. The UE 902 may receive the RRC configuration 907 from the TRP 904 or the TRP 906. The RRC configuration 907 provide, for example, a table that correlates a PUCCH resource indicator (PRI) codepoint in DCI with a number of repetitions for a PUCCH transmission. For example, the table may correlate a PRI of zero with one PUCCH repetition, and may correlate a PRI of one with two PUCCH repetitions.

The TRP 904 or the TRP 906 may output a beam indication DCI or a beam indication MAC-CE 908 to the UE 902. The UE 902 may receive the beam indication DCI or a beam indication MAC-CE 908 from the TRP 904 or the TRP 906. The beam indication DCI or a beam indication MAC-CE 908 may indicate an mTRP operation using a pair of unified TCIs. The pair of unified TCIs may each identify two DL applicable TCIs or two UL applicable TCIs for each of the TRP 904 and the TRP 906. For example, a first TCI may be associated with a PUSCH and a PUCCH of the TRP 904 and a second TCI may be associated with a PUSCH and a PUCCH of the TRP 906. In another aspect, a first TCI may be associated with a PDCCH and a PUCCH of the TRP 904 and a second TCI may be associated with a PDCCH and a PUCCH of the TRP 906.

The TRP 904 or the TRP 906 may output an mTRP scheduling DCI 910 to the UE 902. The UE 902 may receive the mTRP scheduling DCI 910 from the TRP 904 or the TRP 906. The mTRP scheduling DCI 910 may indicate an mTRP communication using the pair of unified TCIs indicated by the beam indication DCI or a beam indication MAC-CE 908. The mTRP scheduling DCI 910 may indicate one or more PUCCH repetitions by the PUCCH resource indicator.

In one aspect, the mTRP scheduling DCI 910 may indicate a TDM PUCCH similar to that of diagram 510 in FIG. 5B, where the UE 902 may transmit a PUCCH to the TRP 904 using the set of resources 512 and transmit a PUCCH to the TRP 906 using the set of resources 514 (i.e., one PUCCH repetition). In another aspect, the mTRP scheduling DCI 910 may indicate a TDM cyclic mapping similar to that of diagram 530 in FIG. 5D, where the UE 902 may transmit a PUCCH to the TRP 904 using the resources 532 and 536, and may transmit a PUCCH to the TRP 906 using the resources 534 and 538. In another aspect, the mTRP scheduling DCI 910 may indicate a TDM sequential mapping similar to that of diagram 540 in FIG. 5E, where the UE 902 may transmit a PUCCH as the mTRP communication 912 to the TRP 904 using the resources 542 and 544, and may transmit a PUCCH as the mTRP communication 914 to the TRP 906 using the resources 546 and 548.

The TRP 904 or the TRP 906 may output an sTRP scheduling DCI 916 to the UE 902. The UE 902 may receive the sTRP scheduling DCI 916 from the TRP 904 or the TRP 906. The sTRP scheduling DCI 916 may indicate one or more PUCCH repetitions by the PUCCH resource indicator. The sTRP scheduling DCI 916 may indicate a selection of a TCI state. In one aspect, a PUUCH resource indicator, such as the PUUCH resource indicator 610 in FIG. 6, may indicate a selection of the TCI state. In one aspect, a TCI selection indicator, such as the TCI selection indicator field 606 in FIG. 6, may indicate a selection of the TCI state. In one aspect, a dedicated field of the sTRP scheduling DCI 916 may indicate to the UE 902 which indicated TCI state applies to the PUUCH of the sTRP communication 922. In one aspect, the dedicated field may be the SRS resource set indicator field 604 in FIG. 6. In one aspect, the dedicated field may be the TCI selection indicator field 606 in FIG. 6.

In response to the sTRP scheduling DCI 916 indicating a TCI state associated with the TRP 904, at 918 the UE 902 may switch to communicating with the TRP 904 in sTRP mode via the sTRP communication 922 by transmitting a PUCCH transmission as the sTRP communication 922 to the TRP 904 and foregoing repeating the PUCCH transmission to the TRP 906. At 920, the TRP 906 may switch to sTRP mode by not monitoring for a PUCCH transmission from the UE 902.

At 924, the UE 902 may switch back to the mTRP mode. The UE 902 may switch back to the mTRP mode in response to completing the sTRP communication 922 (e.g., upon completion of the PUCCH transmission). At 926, the TRP 906 may switch to communicating with the UE 902 in mTRP mode by monitoring for repeated PUCCH transmission from the UE 902.

In one aspect, the beam indication DCI or a beam indication MAC-CE 908 may indicate an mTRP operation using a single unified TCI associated with both of the TRP 904 and the TRP 906. For example, the beam indication DCI or the beam indication MAC-CE 908 may define a first single unified TCI associated with PUCCH for both the TRP 904 and the TRP 906, and a second single unified TCI associated with PUCCH for the TRP 904 and not the TRP 906. In other words, the first single unified TCI may be for transmitting PUCCH using both the set of resources 512 and the set of resources 514 in FIG. 5B, and the second single unified TCI may be for transmitting PUCCH using one of the set of resources 512 or the set of resources 514 in FIG. 5B. In one aspect, the second single unified TCI may be preconfigured or predetermined by a condition, such as a definition in a specification.

The TRP 904 or the TRP 906 may output an mTRP scheduling DCI 910 to the UE 902. The UE 902 may receive the mTRP scheduling DCI 910 from the TRP 904 or the TRP 906. The mTRP scheduling DCI 910 may indicate an mTRP communication using the single unified TCI indicated by the beam indication DCI or a beam indication MAC-CE 908 that is associated with the TRP 904 and the TRP 906. The mTRP communication may be, for example, a repeated PUCCH communication with both the TRP 904 and the TRP 906. The TRP 904 may communicate with the UE 902 via mTRP communication 912 in response to the mTRP scheduling DCI 910, which may be a PUCCH repeated using TDM. The TRP 906 may communicate with the UE 902 via mTRP communication 914 in response to the mTRP scheduling DCI 910, which may be a PUCCH repeated using TDM.

The TRP 904 or the TRP 906 may output an sTRP scheduling DCI 916 to the UE 902. The UE 902 may receive the sTRP scheduling DCI 916 from the TRP 904 or the TRP 906. The sTRP scheduling DCI 916 may indicate a single unified TCI for transmitting one of the two PUCCH. In other words, the sTRP scheduling DCI 916 may indicate a TCI state associated with the TRP 904 and not associated with the TRP 906. The UE 902 may be configured to refrain from, or skip, transmitting a PUCCH transmission to the TRP 906. While the connection flow diagram 900 shows that the sTRP scheduling DCI 916 indicates a single unified TCI associated with the TRP 904 and not associated with the TRP 906, in other aspects, the sTRP scheduling DCI 916 may indicate a selection of a single unified TCI associated with the TRP 906 and not associated with the TRP 904. In response to the sTRP scheduling DCI 916 indicating a single unified TCI for receiving the CORESET associated with the TRP 904, at 918 the UE 902 may refrain from transmitting the PUCCH transmission to the TRP 906.

At 924, the UE 902 may switch back to the mTRP mode. The UE 902 may switch back to the mTRP mode in response to completing the sTRP communication 922 (e.g., upon transmitting the PUCCH transmission). Switching back to the mTRP mode may include transmitting each PUCCH transmission indicated by a PUCCH resource indicator. At 926, the TRP 906 may switch to communicating with the UE 902 in mTRP mode by monitoring for repeated PUCCH transmission from the UE 902.

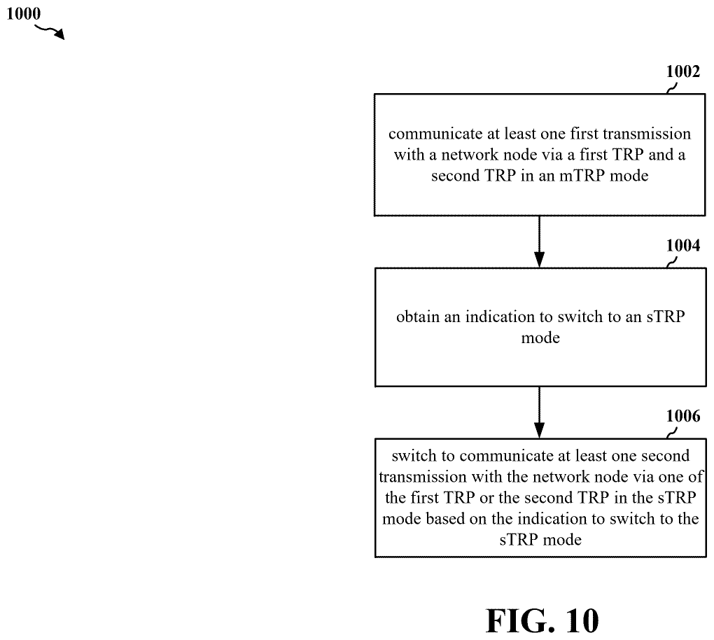

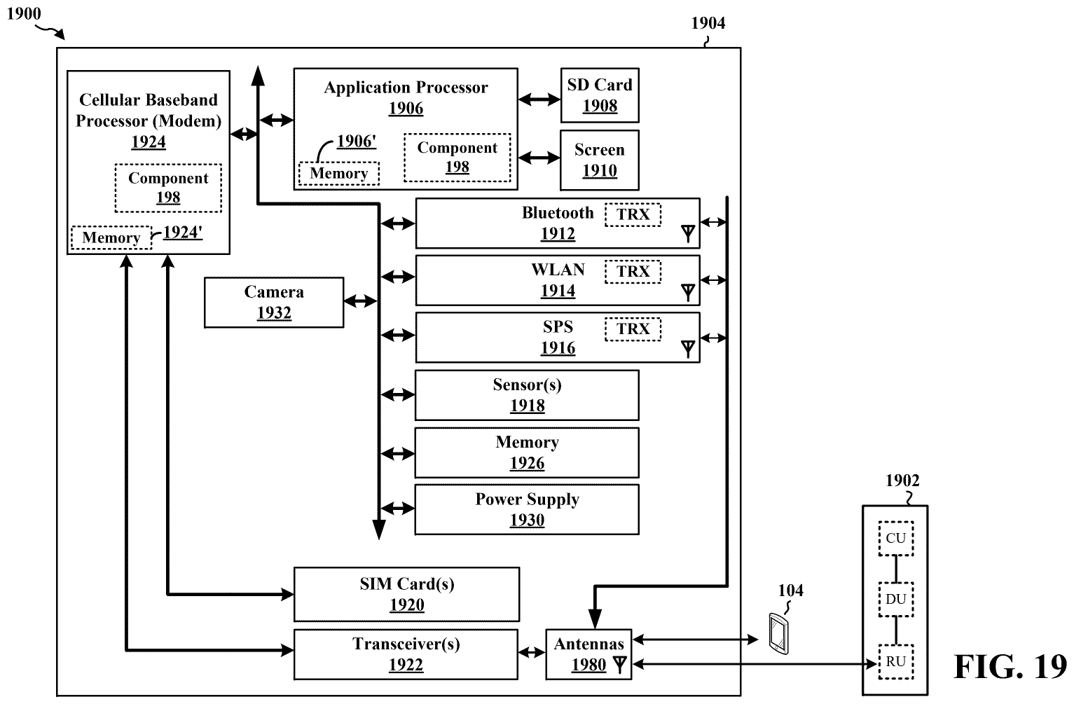

FIG. 10 is a flowchart 1000 of a method of wireless communication. The method may be performed by a UE (e.g., the UE 104, the UE 350, the UE 402, the UE 702, the UE 802, the UE 902; the apparatus 1904). At 1002, the UE may communicate at least one first transmission with a network node via a first TRP and a second TRP in an mTRP mode. For example, 1002 may be performed by component 198 of the apparatus 1904 in FIG. 19.

At 1004, the UE may obtain an indication to switch to an sTRP mode. For example, 1004 may be performed by component 198 of the apparatus 1904 in FIG. 19.

At 1006, the UE may switch to communicate at least one second transmission with the network node via one of the first TRP or the second TRP in the sTRP mode based on the indication to switch to the sTRP mode. For example, 1006 may be performed by component 198 of the apparatus 1904 in FIG. 19.

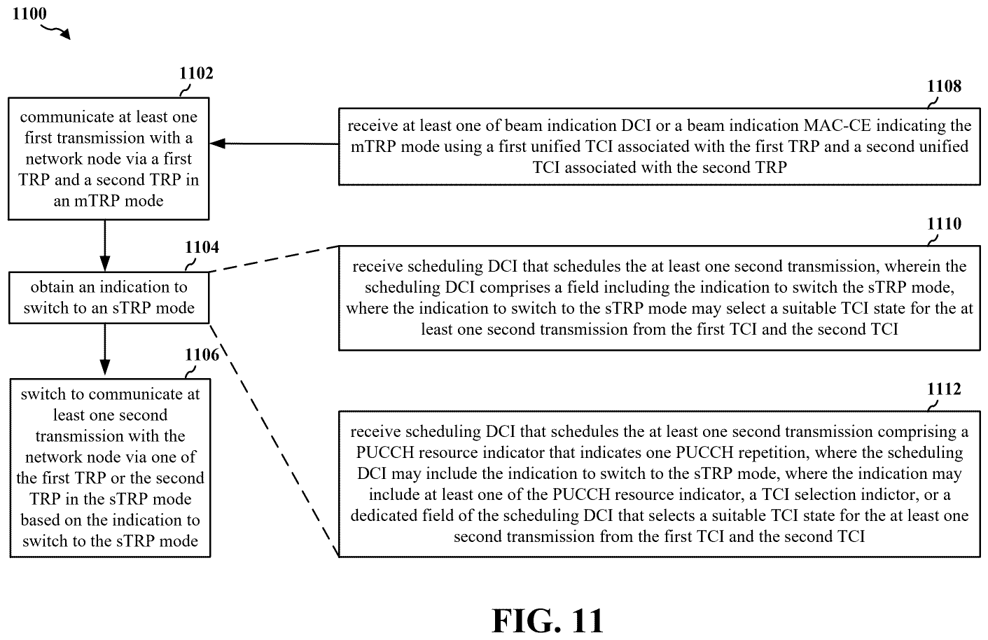

FIG. 11 is a flowchart 1100 of a method of wireless communication. The method may be performed by a UE (e.g., the UE 104, the UE 350, the UE 402, the UE 702, the UE 802, the UE 902; the apparatus 1904). At 1102, the UE may communicate at least one first transmission with a network node via a first TRP and a second TRP in an mTRP mode. For example, 1102 may be performed by component 198 of the apparatus 1904 in FIG. 19.

At 1104, the UE may obtain an indication to switch to an sTRP mode. For example, 1104 may be performed by component 198 of the apparatus 1904 in FIG. 19.

At 1106, the UE may switch to communicate at least one second transmission with the network node via one of the first TRP or the second TRP in the sTRP mode based on the indication to switch to the sTRP mode. For example, 1106 may be performed by component 198 of the apparatus 1904 in FIG. 19.

At 1108, the UE may receive at least one of beam indication DCI or a beam indication MAC-CE indicating the mTRP mode using a first unified TCI associated with the first TRP and a second unified TCI associated with the second TRP. For example, 1108 may be performed by component 198 of the apparatus 1904 in FIG. 19.

At 1110, the UE may receive scheduling DCI that schedules the at least one second transmission, where the scheduling DCI includes a field including the indication to switch the sTRP mode, where the indication to switch to the sTRP mode may select a suitable TCI state for the at least one second transmission from the first TCI and the second TCI. For example, 1110 may be performed by component 198 of the apparatus 1904 in FIG. 19.

At 1112, the UE may receive scheduling DCI that schedules the at least one second transmission including a PUCCH resource indicator that indicates one PUCCH repetition, where the scheduling DCI may include the indication to switch to the sTRP mode, where the indication may include at least one of the PUCCH resource indicator, a TCI selection indictor, or a dedicated field of the scheduling DCI that selects a suitable TCI state for the at least one second transmission from the first TCI and the second TCI. For example, 1112 may be performed by component 198 of the apparatus 1904 in FIG. 19.

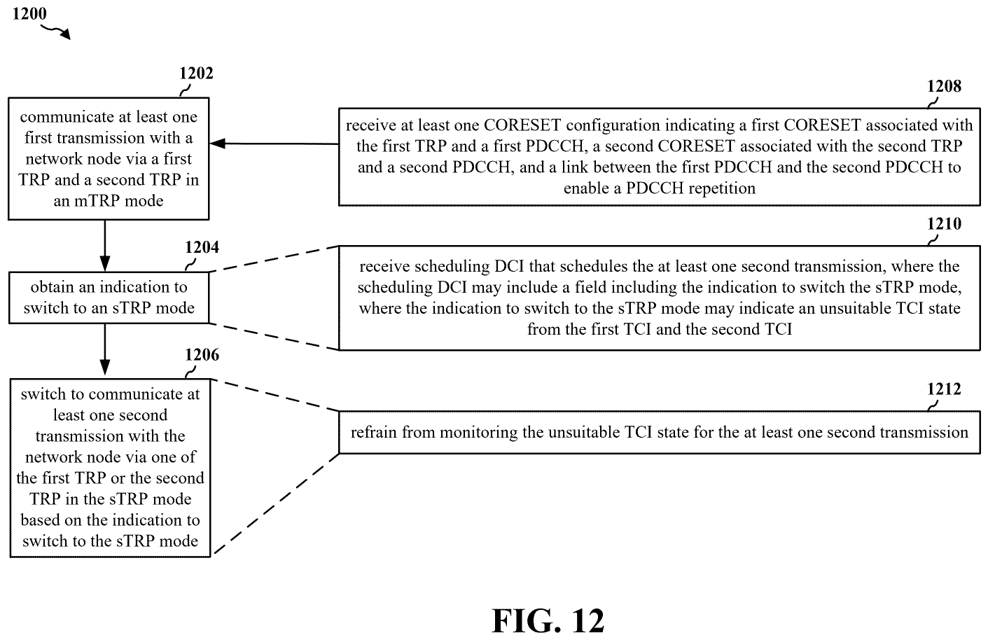

FIG. 12 is a flowchart 1200 of a method of wireless communication. The method may be performed by a UE (e.g., the UE 104, the UE 350, the UE 402, the UE 702, the UE 802, the UE 902; the apparatus 1904). At 1202, the UE may communicate at least one first transmission with a network node via a first TRP and a second TRP in an mTRP mode. For example, 1202 may be performed by component 198 of the apparatus 1904 in FIG. 19.

At 1204, the UE may obtain an indication to switch to an sTRP mode. For example, 1204 may be performed by component 198 of the apparatus 1904 in FIG. 19.

At 1206, the UE may switch to communicate at least one second transmission with the network node via one of the first TRP or the second TRP in the sTRP mode based on the indication to switch to the sTRP mode. For example, 1206 may be performed by component 198 of the apparatus 1904 in FIG. 19.

At 1208, the UE may receive at least one CORESET configuration indicating a first CORESET associated with the first TRP and a first PDCCH, a second CORESET associated with the second TRP and a second PDCCH, and a link between the first PDCCH and the second PDCCH to enable a PDCCH repetition. For example, 1208 may be performed by component 198 of the apparatus 1904 in FIG. 19.

At 1210, the UE may receive scheduling DCI that schedules the at least one second transmission, where the scheduling DCI may include a field including the indication to switch the sTRP mode, where the indication to switch to the sTRP mode may indicate an unsuitable TCI state from the first TCI and the second TCI. For example, 1210 may be performed by component 198 of the apparatus 1904 in FIG. 19.

At 1212, the UE may refrain from monitoring the unsuitable TCI state for the at least one second transmission. For example, 1212 may be performed by component 198 of the apparatus 1904 in FIG. 19.

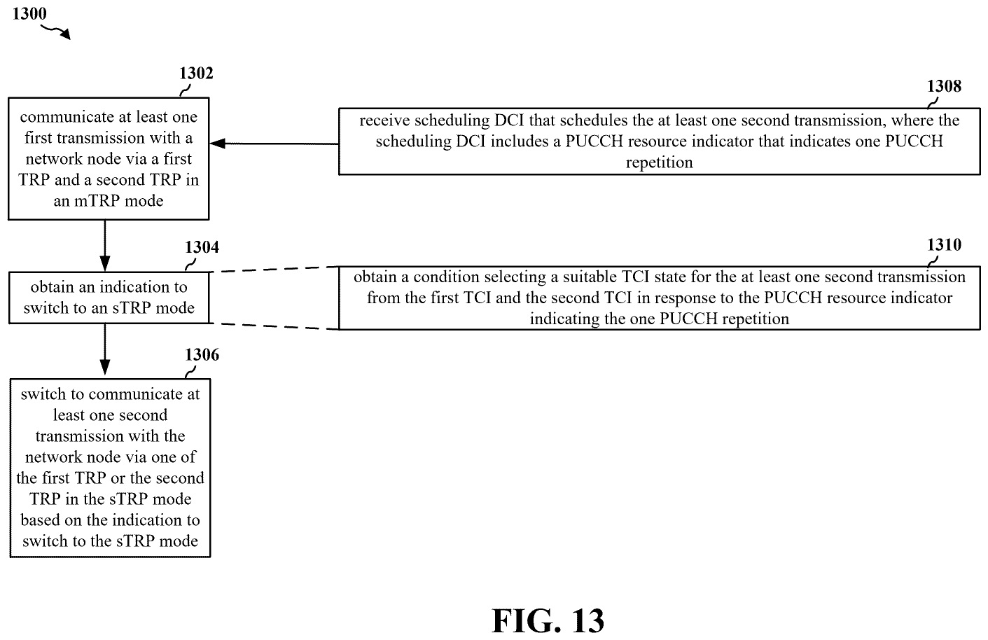

FIG. 13 is a flowchart 1300 of a method of wireless communication. The method may be performed by a UE (e.g., the UE 104, the UE 350, the UE 402, the UE 702, the UE 802, the UE 902; the apparatus 1904). At 1302, the UE may communicate at least one first transmission with a network node via a first TRP and a second TRP in an mTRP mode. For example, 1302 may be performed by component 198 of the apparatus 1904 in FIG. 19.

At 1304, the UE may obtain an indication to switch to an sTRP mode. For example, 1304 may be performed by component 198 of the apparatus 1904 in FIG. 19.

At 1306, the UE may switch to communicate at least one second transmission with the network node via one of the first TRP or the second TRP in the sTRP mode based on the indication to switch to the sTRP mode. For example, 1306 may be performed by component 198 of the apparatus 1904 in FIG. 19.

At 1308, the UE may receive scheduling DCI that schedules the at least one second transmission, where the scheduling DCI includes a PUCCH resource indicator that indicates one PUCCH repetition. For example, 1308 may be performed by component 198 of the apparatus 1904 in FIG. 19.

At 1310, the UE may obtain a condition selecting a suitable TCI state for the at least one second transmission from the first TCI and the second TCI in response to the PUCCH resource indicator indicating the one PUCCH repetition. For example, 1310 may be performed by component 198 of the apparatus 1904 in FIG. 19.

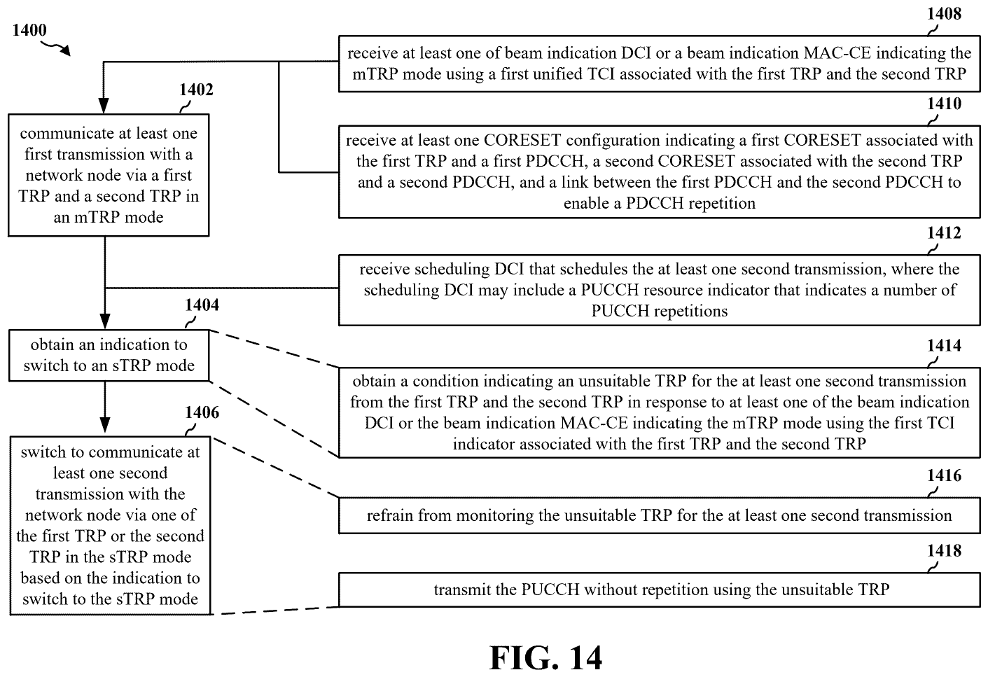

FIG. 14 is a flowchart 1400 of a method of wireless communication. The method may be performed by a UE (e.g., the UE 104, the UE 350, the UE 402, the UE 702, the UE 802, the UE 902; the apparatus 1904). At 1402, the UE may communicate at least one first transmission with a network node via a first TRP and a second TRP in an mTRP mode. For example, 1402 may be performed by component 198 of the apparatus 1904 in FIG. 19.

At 1404, the UE may obtain an indication to switch to an sTRP mode. For example, 1404 may be performed by component 198 of the apparatus 1904 in FIG. 19.

At 1406, the UE may switch to communicate at least one second transmission with the network node via one of the first TRP or the second TRP in the sTRP mode based on the indication to switch to the sTRP mode. For example, 1406 may be performed by component 198 of the apparatus 1904 in FIG. 19.

At 1408, the UE may receive at least one of beam indication DCI or a beam indication MAC-CE indicating the mTRP mode using a first unified TCI associated with the first TRP and the second TRP. For example, 1404 may be performed by component 198 of the apparatus 1904 in FIG. 19.

At 1410, the UE may receive at least one CORESET configuration indicating a first CORESET associated with the first TRP and a first PDCCH, a second CORESET associated with the second TRP and a second PDCCH, and a link between the first PDCCH and the second PDCCH to enable a PDCCH repetition. For example, 1404 may be performed by component 198 of the apparatus 1904 in FIG. 19.

At 1412, the UE may receive scheduling DCI that schedules the at least one second transmission, where the scheduling DCI may include a PUCCH resource indicator that indicates a number of PUCCH repetitions. For example, 1404 may be performed by component 198 of the apparatus 1904 in FIG. 19.

At 1414, the UE may obtain a condition indicating an unsuitable TRP for the at least one second transmission from the first TRP and the second TRP in response to at least one of the beam indication DCI or the beam indication MAC-CE indicating the mTRP mode using the first TCI indicator associated with the first TRP and the second TRP. For example, 1404 may be performed by component 198 of the apparatus 1904 in FIG. 19.

At 1416, the UE may refrain from monitoring the unsuitable TRP for the at least one second transmission. For example, 1404 may be performed by component 198 of the apparatus 1904 in FIG. 19.

At 1418, the UE may transmit the PUCCH without repetition using the unsuitable TRP. For example, 1404 may be performed by component 198 of the apparatus 1904 in FIG. 19.

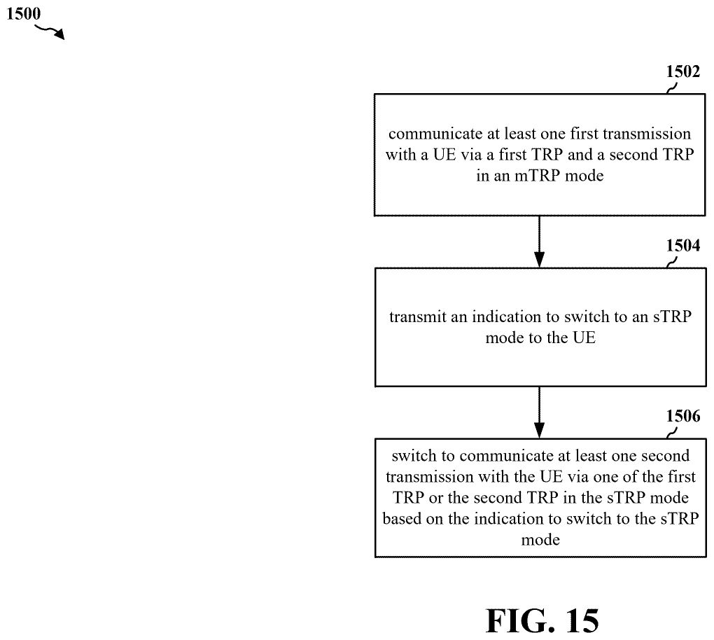

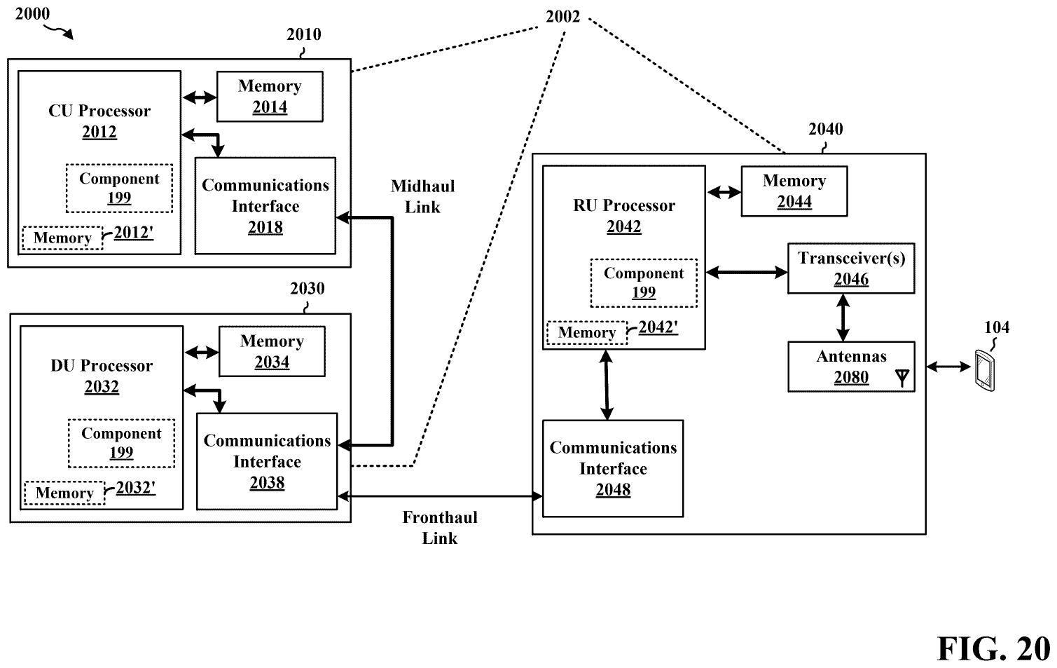

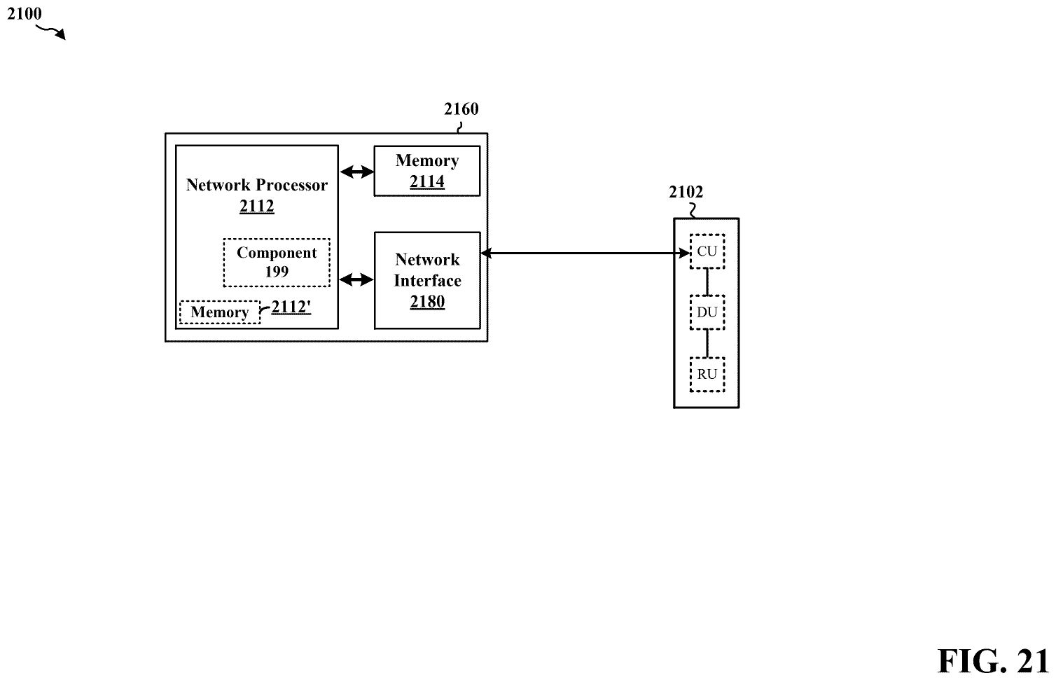

FIG. 15 is a flowchart 1500 of a method of wireless communication. The method may be performed by a network node (e.g., the base station 102, the base station 310; the network node 406; the network entity 1902, the network entity 2002, the network entity 2160). At 1502, the network node may communicate at least one first transmission with a UE via a first TRP and a second TRP in an mTRP mode. For example, 1502 may be performed by component 199 of the network entity 2002 in FIG. 20 or the component 199 of the network entity 2160 in FIG. 21.

At 1504, the network node may transmit an indication to switch to an sTRP mode to the UE. For example, 1504 may be performed by component 199 of the network entity 2002 in FIG. 20 or the component 199 of the network entity 2160 in FIG. 21.

At 1506, the network node may switch to communicate at least one second transmission with the UE via one of the first TRP or the second TRP in the sTRP mode based on the indication to switch to the sTRP mode. For example, 1506 may be performed by component 199 of the network entity 2002 in FIG. 20 or the component 199 of the network entity 2160 in FIG. 21.

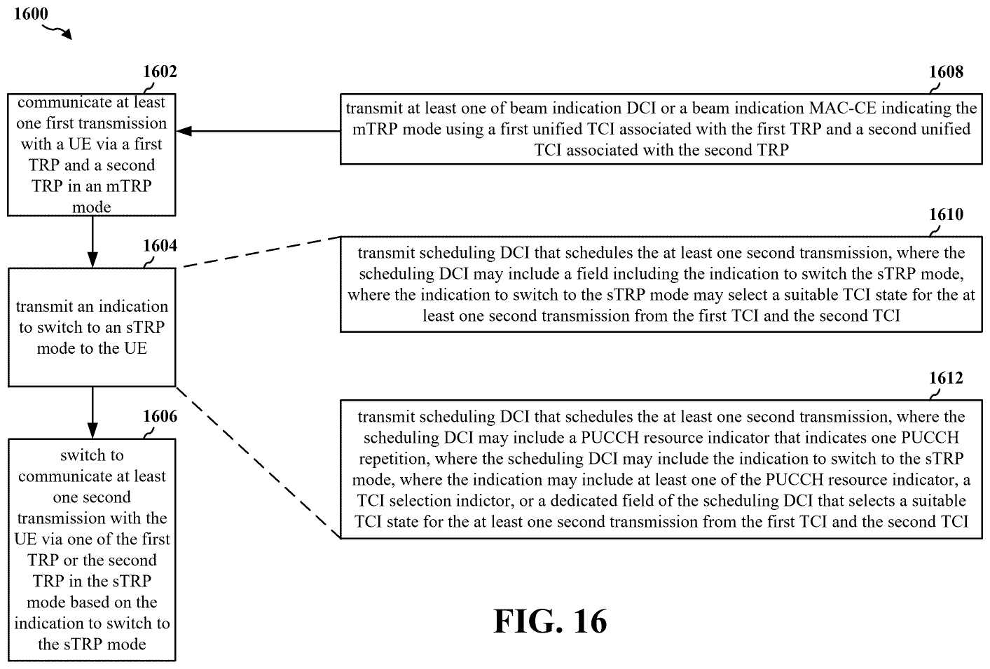

FIG. 16 is a flowchart 1600 of a method of wireless communication. The method may be performed by a network node (e.g., the base station 102, the base station 310; the network node 406; the network entity 1902, the network entity 2002, the network entity 2160). At 1602, the network node may communicate at least one first transmission with a UE via a first TRP and a second TRP in an mTRP mode. For example, 1602 may be performed by component 199 of the network entity 2002 in FIG. 20 or the component 199 of the network entity 2160 in FIG. 21.

At 1604, the network node may transmit an indication to switch to an sTRP mode to the UE. For example, 1604 may be performed by component 199 of the network entity 2002 in FIG. 20 or the component 199 of the network entity 2160 in FIG. 21.

At 1606, the network node may switch to communicate at least one second transmission with the UE via one of the first TRP or the second TRP in the sTRP mode based on the indication to switch to the sTRP mode. For example, 1606 may be performed by component 199 of the network entity 2002 in FIG. 20 or the component 199 of the network entity 2160 in FIG. 21.

At 1608, the network node may transmit at least one of beam indication DCI or a beam indication MAC-CE indicating the mTRP mode using a first unified TCI associated with the first TRP and a second unified TCI associated with the second TRP. For example, 1608 may be performed by component 199 of the network entity 2002 in FIG. 20 or the component 199 of the network entity 2160 in FIG. 21.

At 1610, the network node may transmit scheduling DCI that schedules the at least one second transmission, where the scheduling DCI may include a field including the indication to switch the sTRP mode, where the indication to switch to the sTRP mode may select a suitable TCI state for the at least one second transmission from the first TCI and the second TCI. For example, 1610 may be performed by component 199 of the network entity 2002 in FIG. 20 or the component 199 of the network entity 2160 in FIG. 21.

At 1612, the network node may transmit scheduling DCI that schedules the at least one second transmission, where the scheduling DCI may include a PUCCH resource indicator that indicates one PUCCH repetition, where the scheduling DCI may include the indication to switch to the sTRP mode, where the indication may include at least one of the PUCCH resource indicator, a TCI selection indictor, or a dedicated field of the scheduling DCI that selects a suitable TCI state for the at least one second transmission from the first TCI and the second TCI. For example, 1612 may be performed by component 199 of the network entity 2002 in FIG. 20 or the component 199 of the network entity 2160 in FIG. 21.

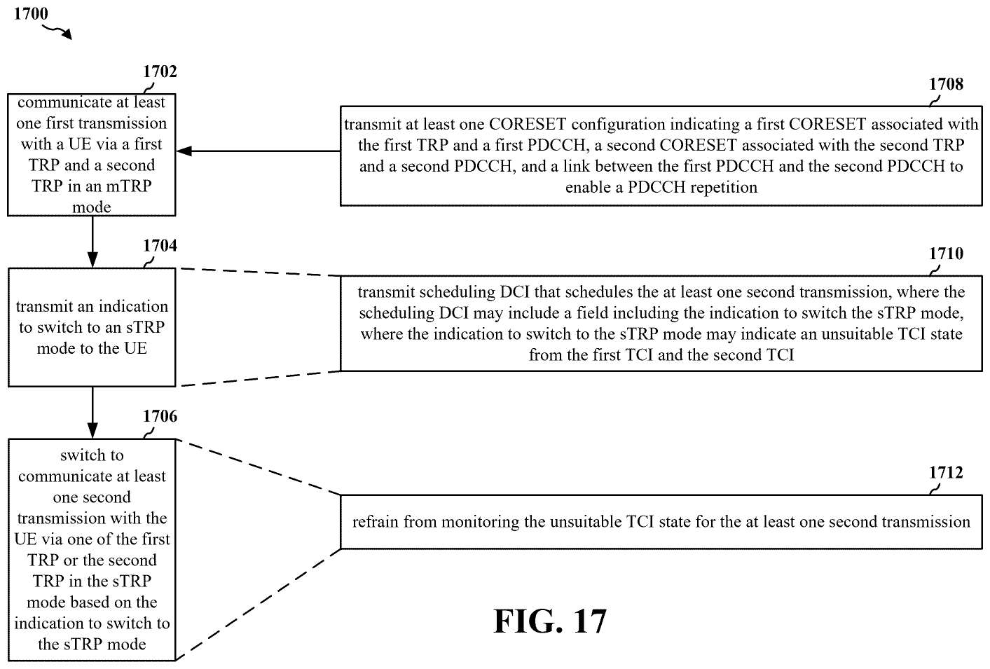

FIG. 17 is a flowchart 1700 of a method of wireless communication. The method may be performed by a network node (e.g., the base station 102, the base station 310; the network node 406; the network entity 1902, the network entity 2002, the network entity 2160). At 1702, the network node may communicate at least one first transmission with a UE via a first TRP and a second TRP in an mTRP mode. For example, 1702 may be performed by component 199 of the network entity 2002 in FIG. 20 or the component 199 of the network entity 2160 in FIG. 21.

At 1704, the network node may transmit an indication to switch to an sTRP mode to the UE. For example, 1704 may be performed by component 199 of the network entity 2002 in FIG. 20 or the component 199 of the network entity 2160 in FIG. 21.

At 1706, the network node may switch to communicate at least one second transmission with the UE via one of the first TRP or the second TRP in the sTRP mode based on the indication to switch to the sTRP mode. For example, 1706 may be performed by component 199 of the network entity 2002 in FIG. 20 or the component 199 of the network entity 2160 in FIG. 21.

At 1708, the network node may transmit at least one CORESET configuration indicating a first CORESET associated with the first TRP and a first PDCCH, a second CORESET associated with the second TRP and a second PDCCH, and a link between the first PDCCH and the second PDCCH to enable a PDCCH repetition. For example, 1708 may be performed by component 199 of the network entity 2002 in FIG. 20 or the component 199 of the network entity 2160 in FIG. 21.

At 1710, the network node may transmit scheduling DCI that schedules the at least one second transmission, where the scheduling DCI may include a field including the indication to switch the sTRP mode, where the indication to switch to the sTRP mode may indicate an unsuitable TCI state from the first TCI and the second TCI. For example, 1710 may be performed by component 199 of the network entity 2002 in FIG. 20 or the component 199 of the network entity 2160 in FIG. 21.

At 1712, the network node may refrain from monitoring the unsuitable TCI state for the at least one second transmission. For example, 1712 may be performed by component 199 of the network entity 2002 in FIG. 20 or the component 199 of the network entity 2160 in FIG. 21.

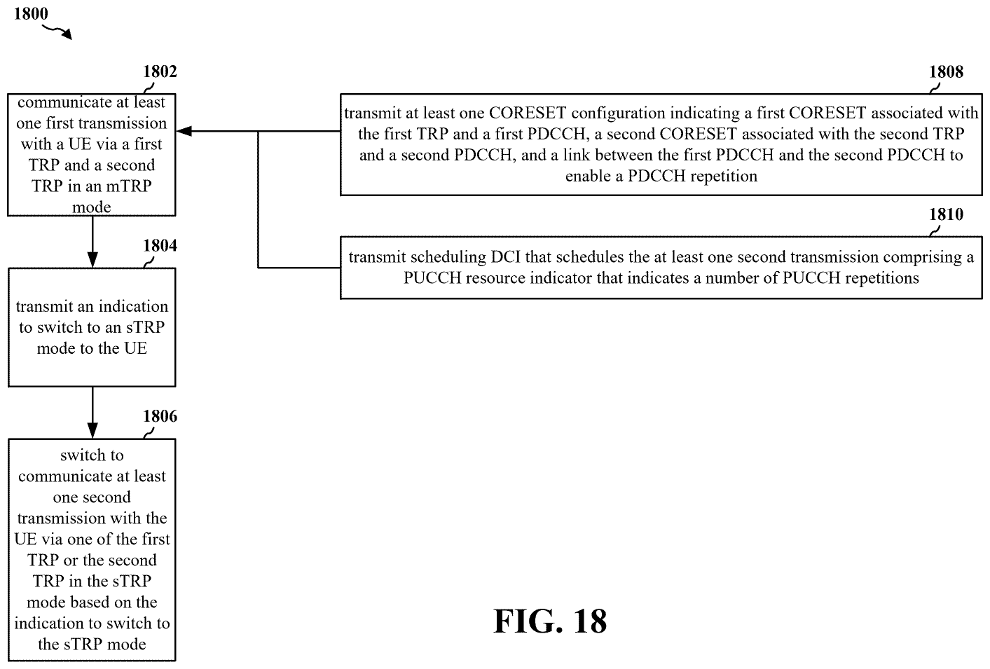

FIG. 18 is a flowchart 1800 of a method of wireless communication. The method may be performed by a network node (e.g., the base station 102, the base station 310; the network node 406; the network entity 1902, the network entity 2002, the network entity 2160). At 1802, the network node may communicate at least one first transmission with a UE via a first TRP and a second TRP in an mTRP mode. For example, 1802 may be performed by component 199 of the network entity 2002 in FIG. 20 or the component 199 of the network entity 2160 in FIG. 21.

At 1804, the network node may transmit an indication to switch to an sTRP mode to the UE. For example, 1804 may be performed by component 199 of the network entity 2002 in FIG. 20 or the component 199 of the network entity 2160 in FIG. 21.

At 1806, the network node may switch to communicate at least one second transmission with the UE via one of the first TRP or the second TRP in the sTRP mode based on the indication to switch to the sTRP mode. For example, 1806 may be performed by component 199 of the network entity 2002 in FIG. 20 or the component 199 of the network entity 2160 in FIG. 21.

At 1808, the network node may transmit at least one CORESET configuration indicating a first CORESET associated with the first TRP and a first PDCCH, a second CORESET associated with the second TRP and a second PDCCH, and a link between the first PDCCH and the second PDCCH to enable a PDCCH repetition. For example, 1808 may be performed by component 199 of the network entity 2002 in FIG. 20 or the component 199 of the network entity 2160 in FIG. 21.

At 1810, the network node may transmit scheduling DCI that schedules the at least one second transmission including a PUCCH resource indicator that indicates a number of PUCCH repetitions. For example, 1810 may be performed by component 199 of the network entity 2002 in FIG. 20 or the component 199 of the network entity 2160 in FIG. 21.

FIG. 19 is a diagram 1900 illustrating an example of a hardware implementation for an apparatus 1904. The apparatus 1904 may be a UE, a component of a UE, or may implement UE functionality. In some aspects, the apparatus 1904 may include a cellular baseband processor 1924 (also referred to as a modem) coupled to one or more transceivers 1922 (e.g., cellular RF transceiver). The cellular baseband processor 1924 may include on-chip memory 1924′. In some aspects, the apparatus 1904 may further include one or more subscriber identity modules (SIM) cards 1920 and an application processor 1906 coupled to a secure digital (SD) card 1908 and a screen 1910. The application processor 1906 may include on-chip memory 1906′. In some aspects, the apparatus 1904 may further include a Bluetooth module 1912, a WLAN module 1914, an SPS module 1916 (e.g., GNSS module), one or more sensor modules 1918 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1926, a power supply 1930, and/or a camera 1932. The Bluetooth module 1912, the WLAN module 1914, and the SPS module 1916 may include an on-chip transceiver (TRX) (or in some cases, just a receiver (RX)). The Bluetooth module 1912, the WLAN module 1914, and the SPS module 1916 may include their own dedicated antennas and/or utilize the antennas 1980 for communication. The cellular baseband processor 1924 communicates through the transceiver(s) 1922 via one or more antennas 1980 with the UE 104 and/or with an RU associated with a network entity 1902. The cellular baseband processor 1924 and the application processor 1906 may each include a computer-readable medium/memory 1924′, 1906′, respectively. The additional memory modules 1926 may also be considered a computer-readable medium/memory. Each computer-readable medium/memory 1924′, 1906′, 1926 may be non-transitory. The cellular baseband processor 1924 and the application processor 1906 are each responsible for general processing, including the execution of software stored on the computer-readable medium/memory. The software, when executed by the cellular baseband processor 1924/application processor 1906, causes the cellular baseband processor 1924/application processor 1906 to perform the various functions described supra. The computer-readable medium/memory may also be used for storing data that is manipulated by the cellular baseband processor 1924/application processor 1906 when executing software. The cellular baseband processor 1924/application processor 1906 may be a component of the UE 350 and may include the memory 360 and/or at least one of the TX processor 368, the RX processor 356, and the controller/processor 359. In one configuration, the apparatus 1904 may be a processor chip (modem and/or application) and include just the cellular baseband processor 1924 and/or the application processor 1906, and in another configuration, the apparatus 1904 may be the entire UE (e.g., see UE 350 of FIG. 3) and include the additional modules of the apparatus 1904.

As discussed supra, the component 198 may be configured to communicate at least one first transmission with a network node via a first TRP and a second TRP in an mTRP mode. The component 198 may be configured to obtain an indication to switch to an sTRP mode. The component 198 may be configured to switch to communicate at least one second transmission with the network node via one of the first TRP or the second TRP in the sTRP mode based on the indication to switch to the sTRP mode. The component 198 may be within the cellular baseband processor 1924, the application processor 1906, or both the cellular baseband processor 1924 and the application processor 1906. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1904 may include a variety of components configured for various functions. In one configuration, the apparatus 1904, and in particular the cellular baseband processor 1924 and/or the application processor 1906, includes means for communicating at least one first transmission with a network node via a first TRP and a second TRP in an mTRP mode. The apparatus 1904 may include means for obtaining an indication to switch to an sTRP mode. The apparatus 1904 may include means for switching to communicate at least one second transmission with the network node via one of the first TRP or the second TRP in the sTRP mode based on the indication to switch to the sTRP mode. The apparatus 1904 may include means for receiving at least one of beam indication DCI or a beam indication MAC-CE indicating the mTRP mode using a first unified transmission configuration indicator TCI associated with the first TRP and a second unified TCI associated with the second TRP. The apparatus 1904 may include means for obtaining the indication to switch to the sTRP mode by receiving scheduling DCI that schedules the at least one second transmission. The apparatus 1904 may include means for obtaining the indication to switch to the sTRP mode by receiving scheduling DCI that schedules the at least one second transmission. The apparatus 1904 may include means for switching to communicate the at least one second transmission with the network node via one of the first TRP or the second TRP in the sTRP mode by refraining from monitoring the unsuitable TCI state for the at least one second transmission. The apparatus 1904 may include means for obtaining the indication to switch to the sTRP mode by receiving scheduling DCI that schedules the at least one second transmission including a PUCCH resource indicator that indicates one PUCCH repetition. The apparatus 1904 may include means for receiving scheduling DCI that schedules the at least one second transmission including a PUCCH resource indicator that indicates one PUCCH repetition. The apparatus 1904 may include means for obtaining the indication to switch to the sTRP mode by obtaining a condition selecting a suitable TCI state for the at least one second transmission from the first TCI and the second TCI in response to the PUCCH resource indicator indicating the one PUCCH repetition. The apparatus 1904 may include means for receiving at least one of beam indication DCI or a beam indication MAC-CE indicating the mTRP mode using a first unified TCI associated with the first TRP and the second TRP. The apparatus 1904 may include means for obtaining the indication to switch to the sTRP mode by obtaining a condition indicating an unsuitable TRP for the at least one second transmission from the first TRP and the second TRP in response to at least one of the beam indication DCI or the beam indication MAC-CE indicating the mTRP mode using the first TCI indicator associated with the first TRP and the second TRP. The apparatus 1904 may include means for receiving at least one CORESET configuration indicating a first CORESET associated with the first TRP and a first PDCCH, a second CORESET associated with the second TRP and a second PDCCH, and a link between the first PDCCH and the second PDCCH to enable a PDCCH repetition. The apparatus 1904 may include means for switching to communicate the at least one second transmission by refraining from monitoring the unsuitable TRP for the at least one second transmission. The apparatus 1904 may include means for receiving scheduling DCI that schedules the at least one second transmission including a PUCCH resource indicator that indicates a number of PUCCH repetitions. The apparatus 1904 may include means for switching to communicate the at least one second transmission by transmitting the PUCCH without repetition using the unsuitable TRP. The means may be the component 198 of the apparatus 1904 configured to perform the functions recited by the means. As described supra, the apparatus 1904 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 20 is a diagram 2000 illustrating an example of a hardware implementation for a network entity 2002. The network entity 2002 may be a BS, a component of a BS, or may implement BS functionality. The network entity 2002 may include at least one of a CU 2010, a DU 2030, or an RU 2040. For example, depending on the layer functionality handled by the component 199, the network entity 2002 may include the CU 2010; both the CU 2010 and the DU 2030; each of the CU 2010, the DU 2030, and the RU 2040; the DU 2030; both the DU 2030 and the RU 2040; or the RU 2040. The CU 2010 may include a CU processor 2012. The CU processor 2012 may include on-chip memory 2012′. In some aspects, the CU 2010 may further include additional memory modules 2014 and a communications interface 2018. The CU 2010 communicates with the DU 2030 through a midhaul link, such as an F1 interface. The DU 2030 may include a DU processor 2032. The DU processor 2032 may include on-chip memory 2032′. In some aspects, the DU 2030 may further include additional memory modules 2034 and a communications interface 2038. The DU 2030 communicates with the RU 2040 through a fronthaul link. The RU 2040 may include an RU processor 2042. The RU processor 2042 may include on-chip memory 2042′. In some aspects, the RU 2040 may further include additional memory modules 2044, one or more transceivers 2046, antennas 2080, and a communications interface 2048. The RU 2040 communicates with the UE 104. The on-chip memory 2012′, 2032′, 2042′ and the additional memory modules 2014, 2034, 2044 may each be considered a computer-readable medium/memory. Each computer-readable medium/memory may be non-transitory. Each of the processors 2012, 2032, 2042 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to communicate at least one first transmission with a UE via a first TRP and a second TRP in an mTRP mode. The component 199 may be configured to transmit an indication to switch to an sTRP mode to the UE. The component 199 may be configured to switch to communicate at least one second transmission with the UE via one of the first TRP or the second TRP in the sTRP mode based on the indication to switch to the sTRP mode. The component 199 may be within one or more processors of one or more of the CU 2010, DU 2030, and the RU 2040. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2002 may include a variety of components configured for various functions. In one configuration, the network entity 2002 may include means for communicating at least one first transmission with a UE via a first TRP and a second TRP in an mTRP mode. The network entity 2002 may include means for transmitting an indication to switch to an sTRP mode to the UE. The network entity 2002 may include means for switching to communicate at least one second transmission with the UE via one of the first TRP or the second TRP in the sTRP mode based on the indication to switch to the sTRP mode. The network entity 2002 may include means for transmitting at least one of beam indication DCI or a beam indication MAC-CE indicating the mTRP mode using a first unified TCI associated with the first TRP and a second unified TCI associated with the second TRP. The network entity 2002 may include means for transmitting the indication to switch to the sTRP mode by transmitting scheduling DCI that schedules the at least one second transmission. The network entity 2002 may include means for transmitting at least one CORESET configuration indicating a first CORESET associated with the first TRP and a first PDCCH, a second CORESET associated with the second TRP and a second PDCCH, and a link between the first PDCCH and the second PDCCH to enable a PDCCH repetition. The network entity 2002 may include means for transmitting the indication to switch to the sTRP mode may include transmitting scheduling DCI that schedules the at least one second transmission. The network entity 2002 may include means for switching to communicate the at least one second transmission with the network node via one of the first TRP or the second TRP in the sTRP mode by refraining from monitoring the unsuitable TCI state for the at least one second transmission. The network entity 2002 may include means for transmitting the indication to switch to the sTRP mode by transmitting scheduling DCI that schedules the at least one second transmission including a PUCCH resource indicator that indicates one PUCCH repetition. The network entity 2002 may include means for transmitting at least one CORESET configuration indicating a first CORESET associated with the first TRP and a first PDCCH, a second CORESET associated with the second TRP and a second PDCCH, and a link between the first PDCCH and the second PDCCH to enable a PDCCH repetition. The network entity 2002 may include means for transmitting scheduling DCI that schedules the at least one second transmission including a PUCCH resource indicator that indicates a number of PUCCH repetitions. The means may be the component 199 of the network entity 2002 configured to perform the functions recited by the means. As described supra, the network entity 2002 may include the TX processor 316, the RX processor 370, and the controller/processor 375. As such, in one configuration, the means may be the TX processor 316, the RX processor 370, and/or the controller/processor 375 configured to perform the functions recited by the means.

FIG. 21 is a diagram 2100 illustrating an example of a hardware implementation for a network entity 2160. In one example, the network entity 2160 may be within the core network 120. The network entity 2160 may include a network processor 2112. The network processor 2112 may include on-chip memory 2112′. In some aspects, the network entity 2160 may further include additional memory modules 2114. The network entity 2160 communicates via the network interface 2180 directly (e.g., backhaul link) or indirectly (e.g., through a RIC) with the CU 2102. The on-chip memory 2112′ and the additional memory modules 2114 may each be considered a computer-readable medium/memory. Each computer-readable medium/memory may be non-transitory. The processor 2112 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component the component 199 may be configured to communicate at least one first transmission with a UE via a first TRP and a second TRP in an mTRP mode. The component 199 may be configured to transmit an indication to switch to an sTRP mode to the UE. The component 199 may be configured to switch to communicate at least one second transmission with the UE via one of the first TRP or the second TRP in the sTRP mode based on the indication to switch to the sTRP mode. The component 199 may be within the processor 2112. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2160 may include a variety of components configured for various functions. In one configuration, the network entity 2160 includes means for communicating at least one first transmission with a UE via a first TRP and a second TRP in an mTRP mode. The network entity 2160 may include means for transmitting an indication to switch to an sTRP mode to the UE. The network entity 2160 may include means for switching to communicate at least one second transmission with the UE via one of the first TRP or the second TRP in the sTRP mode based on the indication to switch to the sTRP mode. The network entity 2160 may include means for transmitting at least one of beam indication DCI or a beam indication MAC-CE indicating the mTRP mode using a first unified TCI associated with the first TRP and a second unified TCI associated with the second TRP. The network entity 2160 may include means for transmitting the indication to switch to the sTRP mode by transmitting scheduling DCI that schedules the at least one second transmission. The network entity 2160 may include means for transmitting at least one CORESET configuration indicating a first CORESET associated with the first TRP and a first PDCCH, a second CORESET associated with the second TRP and a second PDCCH, and a link between the first PDCCH and the second PDCCH to enable a PDCCH repetition. The network entity 2160 may include means for transmitting the indication to switch to the sTRP mode may include transmitting scheduling DCI that schedules the at least one second transmission. The network entity 2160 may include means for switching to communicate the at least one second transmission with the network node via one of the first TRP or the second TRP in the sTRP mode by refraining from monitoring the unsuitable TCI state for the at least one second transmission. The network entity 2160 may include means for transmitting the indication to switch to the sTRP mode by transmitting scheduling DCI that schedules the at least one second transmission including a PUCCH resource indicator that indicates one PUCCH repetition. The network entity 2160 may include means for transmitting at least one CORESET configuration indicating a first CORESET associated with the first TRP and a first PDCCH, a second CORESET associated with the second TRP and a second PDCCH, and a link between the first PDCCH and the second PDCCH to enable a PDCCH repetition. The network entity 2160 may include means for transmitting scheduling DCI that schedules the at least one second transmission including a PUCCH resource indicator that indicates a number of PUCCH repetitions. The means may be the component 199 of the network entity 2160 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data.

The following aspects are illustrative only and may be combined with other aspects or teachings described herein, without limitation.

Aspect 1 is a method of wireless communication at a UE, where the method may include communicating at least one first transmission with a network node via a first TRP and a second TRP in an mTRP mode. The method may include obtaining an indication to switch to an sTRP mode. The method may include switching to communicate at least one second transmission with the network node via one of the first TRP or the second TRP in the sTRP mode based on the indication to switch to the sTRP mode.

Aspect 2 is the method of aspect 1, where the method may include receiving at least one of beam indication DCI or a beam indication MAC-CE indicating the mTRP mode using a first unified transmission configuration indicator TCI associated with the first TRP and a second unified TCI associated with the second TRP.

Aspect 3 is the method of aspect 2, where the first TCI is associated with a first PDSCH and the second TCI is associated with a second PDSCH, or where the first TCI is associated with a first PUSCH and the second TCI is associated with a second PUSCH.

Aspect 4 is the method of any of aspects 2 to 3, where obtaining the indication to switch to the sTRP mode may include receiving scheduling DCI that schedules the at least one second transmission. The scheduling DCI may include a field including the indication to switch the sTRP mode. The indication to switch to the sTRP mode may select a suitable TCI state for the at least one second transmission from the first TCI and the second TCI.

Aspect 5 is the method of aspect 4, where the field may include at least one of an SRS resource set indicator field or a TCI selection indicator field for the indication.

Aspect 6 is the method of any of aspects 4 to 5, where the field may include a TDRA field including the indication to switch to the sTRP mode.

Aspect 7 is the method of aspect 6, where the TDRA field may include at least one of a slot offset value, an SLIV, or a TCI selection indicator including the indication associated with the at least one second transmission.

Aspect 8 is the method of any of aspects 4 to 7, where the field includes a TCI field including a dedicated bit including the indication.

Aspect 9 is the method of aspect 2, where the method may include receiving at least one CORESET configuration indicating a first CORESET associated with the first TRP and a first PDCCH, a second CORESET associated with the second TRP and a second PDCCH, and a link between the first PDCCH and the second PDCCH to enable a PDCCH repetition.

Aspect 10 is the method of aspect 9, where obtaining the indication to switch to the sTRP mode may include receiving scheduling DCI that schedules the at least one second transmission. The scheduling DCI may include a field including the indication to switch the sTRP mode. The indication to switch to the sTRP mode may indicate an unsuitable TCI state from the first TCI and the second TCI.

Aspect 11 is the method of any of aspects 9 to 10, where switching to communicate the at least one second transmission with the network node via one of the first TRP or the second TRP in the sTRP mode may include refraining from monitoring the unsuitable TCI state for the at least one second transmission.

Aspect 12 is the method of aspect 2, where obtaining the indication to switch to the sTRP mode may include receiving scheduling DCI that schedules the at least one second transmission including a PUCCH resource indicator that indicates one PUCCH repetition. The scheduling DCI may include the indication to switch to the sTRP mode. The indication may include at least one of the PUCCH resource indicator, a TCI selection indictor, or a dedicated field of the scheduling DCI that selects a suitable TCI state for the at least one second transmission from the first TCI and the second TCI.

Aspect 13 is the method of aspect 2, where the method may include receiving scheduling DCI that schedules the at least one second transmission including a PUCCH resource indicator that indicates one PUCCH repetition. Obtaining the indication to switch to the sTRP mode may include obtaining a condition selecting a suitable TCI state for the at least one second transmission from the first TCI and the second TCI in response to the PUCCH resource indicator indicating the one PUCCH repetition.

Aspect 14 is the method of aspect 1, where the method may include receiving at least one of beam indication DCI or a beam indication MAC-CE indicating the mTRP mode using a first unified TCI associated with the first TRP and the second TRP. Obtaining the indication to switch to the sTRP mode may include obtaining a condition indicating an unsuitable TRP for the at least one second transmission from the first TRP and the second TRP in response to at least one of the beam indication DCI or the beam indication MAC-CE indicating the mTRP mode using the first TCI indicator associated with the first TRP and the second TRP.

Aspect 15 is the method of aspect 14, where the method may include receiving at least one CORESET configuration indicating a first CORESET associated with the first TRP and a first PDCCH, a second CORESET associated with the second TRP and a second PDCCH, and a link between the first PDCCH and the second PDCCH to enable a PDCCH repetition. Switching to communicate the at least one second transmission may include refraining from monitoring the unsuitable TRP for the at least one second transmission.

Aspect 16 is the method of aspect 14, where the method may include receiving scheduling DCI that schedules the at least one second transmission including a PUCCH resource indicator that indicates a number of PUCCH repetitions. Switching to communicate the at least one second transmission may include transmitting the PUCCH without repetition using the unsuitable TRP.

Aspect 17 is a method of wireless communication at a network node, where the method may include communicating at least one first transmission with a UE via a first TRP and a second TRP in an mTRP mode. The method may include transmitting an indication to switch to an sTRP mode to the UE. The method may include switching to communicate at least one second transmission with the UE via one of the first TRP or the second TRP in the sTRP mode based on the indication to switch to the sTRP mode.

Aspect 18 is the method of aspect 17, where the method may include transmitting at least one of beam indication DCI or a beam indication MAC-CE indicating the mTRP mode using a first unified TCI associated with the first TRP and a second unified TCI associated with the second TRP.

Aspect 19 is the method of aspect 18, where the first TCI is associated with a first PDSCH and the second TCI is associated with a second PDSCH, or where the first TCI is associated with a first PUSCH and the second TCI is associated with a second PUSCH.

Aspect 20 is the method of any of aspects 18 to 19, where transmitting the indication to switch to the sTRP mode may include transmitting scheduling DCI that schedules the at least one second transmission. The scheduling DCI may include a field including the indication to switch the sTRP mode. The indication to switch to the sTRP mode may select a suitable TCI state for the at least one second transmission from the first TCI and the second TCI.

Aspect 21 is the method of aspect 20, where the field may include at least one of an SRS resource set indicator field or a TCI selection indicator field for the indication.

Aspect 22 is the method of any of aspects 20 to 21, where the field may include a TDRA field including the indication to switch to the sTRP mode.

Aspect 23 is the method of aspect 22, where the TDRA field may include at least one of a slot offset value, an SLIV, or a TCI selection indicator including the indication associated with the at least one second transmission.

Aspect 24 is the method of aspect 20, where the field may include a TCI field including a dedicated bit including the indication.

Aspect 25 is the method of aspect 18, where the method may include transmitting at least one CORESET configuration indicating a first CORESET associated with the first TRP and a first PDCCH, a second CORESET associated with the second TRP and a second PDCCH, and a link between the first PDCCH and the second PDCCH to enable a PDCCH repetition.

Aspect 26 is the method of aspect 25, where transmitting the indication to switch to the sTRP mode may include transmitting scheduling DCI that schedules the at least one second transmission. The scheduling DCI may include a field including the indication to switch the sTRP mode. The indication to switch to the sTRP mode may indicate an unsuitable TCI state from the first TCI and the second TCI.

Aspect 27 is the method of aspect 26, where switching to communicate the at least one second transmission with the network node via one of the first TRP or the second TRP in the sTRP mode may include refraining from monitoring the unsuitable TCI state for the at least one second transmission.

Aspect 28 is the method of aspect 18, where transmitting the indication to switch to the sTRP mode may include transmitting scheduling DCI that schedules the at least one second transmission including a PUCCH resource indicator that indicates one PUCCH repetition. The scheduling DCI may include the indication to switch to the sTRP mode. The indication may include at least one of the PUCCH resource indicator, a TCI selection indictor, or a dedicated field of the scheduling DCI that selects a suitable TCI state for the at least one second transmission from the first TCI and the second TCI.

Aspect 29 is the method of aspect 17, where the method may include transmitting at least one CORESET configuration indicating a first CORESET associated with the first TRP and a first PDCCH, a second CORESET associated with the second TRP and a second PDCCH, and a link between the first PDCCH and the second PDCCH to enable a PDCCH repetition.

Aspect 30 is the method of aspect 17, where the method may include transmitting scheduling DCI that schedules the at least one second transmission including a PUCCH resource indicator that indicates a number of PUCCH repetitions.

Aspect 31 is an apparatus for wireless communication, including: a memory; and at least one processor coupled to the memory and, based at least in part on information stored in the memory, the at least one processor is configured to implement any of aspects 1 to 30.

Aspect 32 is the apparatus of aspect 31, further including at least one of an antenna or a transceiver coupled to the at least one processor.

Aspect 33 is an apparatus for wireless communication including means for implementing any of aspects 1 to 30.

Aspect 34 is a computer-readable medium (e.g., a non-transitory computer-readable medium) storing computer executable code, where the code when executed by a processor causes the processor to implement any of aspects 1 to 30.

What is claimed is:

1. An apparatus for wireless communication at a user equipment (UE), comprising:
a memory; and
at least one processor coupled to the memory and, based at least in part on information stored in the memory, the at least one processor is configured to:
communicate at least one first transmission with a network node via a first transmission-reception point (TRP) and a second TRP in a multiple TRP (mTRP) mode;
obtain an indication to switch to a single TRP (sTRP) mode; and
switch to communicate at least one second transmission with the network node via one of the first TRP or the second TRP in the sTRP mode based on the indication to switch to the sTRP mode.

2. The apparatus of claim 1, wherein the at least one processor is further configured to:
receive at least one of beam indication downlink control information (DCI) or a beam indication medium access control (MAC) control element (MAC-CE) indicating the mTRP mode using a first unified transmission configuration indicator (TCI) associated with the first TRP and a second unified TCI associated with the second TRP.

3. The apparatus of claim 2, wherein the first TCI is associated with a first physical downlink shared channel (PDSCH) and the second TCI is associated with a second PDSCH, or wherein the first TCI is associated with a first physical uplink shared channel (PUSCH) and the second TCI is associated with a second PUSCH.

4. The apparatus of claim 2, wherein, to obtain the indication to switch to the sTRP mode, the at least one processor is further configured to:
receive scheduling DCI that schedules the at least one second transmission, wherein the scheduling DCI comprises a field including the indication to switch the sTRP mode, wherein the indication to switch to the sTRP mode selects a suitable TCI state for the at least one second transmission from the first TCI and the second TCI.

5. The apparatus of claim 4, wherein the field comprises at least one of a sounding reference signal (SRS) resource set indicator field or a TCI selection indicator field for the indication.

6. The apparatus of claim 4, wherein the field comprises a time domain resource allocation (TDRA) field including the indication to switch to the sTRP mode.

7. The apparatus of claim 6, wherein the TDRA field comprises at least one of a slot offset value, a start and length indicator value (SLIV), or a TCI selection indicator comprising the indication associated with the at least one second transmission.

8. The apparatus of claim 4, wherein the field comprises a TCI field including a dedicated bit comprising the indication.

9. The apparatus of claim 2, wherein the at least one processor is further configured to:
receive at least one control resource set (CORESET) configuration indicating a first CORESET associated with the first TRP and a first physical downlink control channel (PDCCH), a second CORESET associated with the second TRP and a second PDCCH, and a link between the first PDCCH and the second PDCCH to enable a PDCCH repetition.

10. The apparatus of claim 9, wherein, to obtain the indication to switch to the sTRP mode, the at least one processor is further configured to:
receive scheduling DCI that schedules the at least one second transmission, wherein the scheduling DCI comprises a field including the indication to switch the sTRP mode, wherein the indication to switch to the sTRP mode indicates an unsuitable TCI state from the first TCI and the second TCI.

11. The apparatus of claim 10, wherein, to switch to communicate the at least one second transmission with the network node via one of the first TRP or the second TRP in the sTRP mode, the at least one processor is further configured to:
refrain from monitoring the unsuitable TCI state for the at least one second transmission.

12. The apparatus of claim 2, wherein, to obtain the indication to switch to the sTRP mode, the at least one processor is further configured to:
receive scheduling DCI that schedules the at least one second transmission comprising a physical uplink control channel (PUCCH) resource indicator that indicates one PUCCH repetition, wherein the scheduling DCI comprises the indication to switch to the sTRP mode, wherein the indication comprises at least one of the PUCCH resource indicator, a TCI selection indictor, or a dedicated field of the scheduling DCI that selects a suitable TCI state for the at least one second transmission from the first TCI and the second TCI.

13. The apparatus of claim 2, wherein the at least one processor is further configured to:
receive scheduling DCI that schedules the at least one second transmission comprising a PUCCH resource indicator that indicates one PUCCH repetition, wherein obtaining the indication to switch to the sTRP mode comprises obtaining a condition selecting a suitable TCI state for the at least one second transmission from the first TCI and the second TCI in response to the PUCCH resource indicator indicating the one PUCCH repetition.

14. The apparatus of claim 1, wherein the at least one processor is further configured to:
receive at least one of beam indication DCI or a beam indication MAC-CE indicating the mTRP mode using a first unified TCI associated with the first TRP and the second TRP, wherein obtaining the indication to switch to the sTRP mode comprises obtaining a condition indicating an unsuitable TRP for the at least one second transmission from the first TRP and the second TRP in response to at least one of the beam indication DCI or the beam indication MAC-CE indicating the mTRP mode using the first TCI indicator associated with the first TRP and the second TRP.

15. The apparatus of claim 14, wherein the at least one processor is further configured to:
receive at least one CORESET configuration indicating a first CORESET associated with the first TRP and a first PDCCH, a second CORESET associated with the second TRP and a second PDCCH, and a link between the first PDCCH and the second PDCCH to enable a PDCCH repetition, wherein switching to communicate the at least one second transmission comprises refraining from monitoring the unsuitable TRP for the at least one second transmission.

16. The apparatus of claim 14, wherein the at least one processor is further configured to:
receive scheduling DCI that schedules the at least one second transmission comprising a PUCCH resource indicator that indicates a number of PUCCH repetitions, wherein switching to communicate the at least one second transmission comprises transmitting the PUCCH without repetition using the unsuitable TRP.

17. The apparatus of claim 1, further comprising a transceiver coupled to the at least one processor, wherein to communicate the at least one first transmission with the network node comprises communicating the at least one first transmission with the network node with the transceiver.

18. An apparatus for wireless communication at a network node, comprising:
a memory; and
at least one processor coupled to the memory and, based at least in part on information stored in the memory, the at least one processor is configured to:
communicate at least one first transmission with a user equipment (UE) via a first transmission-reception point (TRP) and a second TRP in a multiple TRP (mTRP) mode;
transmit an indication to switch to a single TRP (sTRP) mode to the UE; and
switch to communicate at least one second transmission with the UE via one of the first TRP or the second TRP in the sTRP mode based on the indication to switch to the sTRP mode.

19. The apparatus of claim 18, wherein the at least one processor is further configured to:
transmit at least one of beam indication downlink control information (DCI) or a beam indication medium access control (MAC) control element (MAC-CE) indicating the mTRP mode using a first unified transmission configuration indicator (TCI) associated with the first TRP and a second unified TCI associated with the second TRP.

20. The apparatus of claim 19, wherein the first TCI is associated with a first physical downlink shared channel (PDSCH) and the second TCI is associated with a second PDSCH, or wherein the first TCI is associated with a first physical uplink shared channel (PUSCH) and the second TCI is associated with a second PUSCH.

21. The apparatus of claim 19, wherein, to transmit the indication to switch to the sTRP mode, the at least one processor is further configured to:
transmit scheduling DCI that schedules the at least one second transmission, wherein the scheduling DCI comprises a field including the indication to switch the sTRP mode, wherein the indication to switch to the sTRP mode selects a suitable TCI state for the at least one second transmission from the first TCI and the second TCI.

22. The apparatus of claim 21, wherein the field comprises at least one of a sounding reference signal (SRS) resource set indicator field or a TCI selection indicator field for the indication.

23. The apparatus of claim 21, wherein the field comprises a time domain resource allocation (TDRA) field including the indication to switch to the sTRP mode.

24. The apparatus of claim 23, wherein the TDRA field comprises at least one of a slot offset value, a start and length indicator value (SLIV), or a TCI selection indicator comprising the indication associated with the at least one second transmission.

25. The apparatus of claim 19, wherein the at least one processor is further configured to:
transmit at least one control resource set (CORESET) configuration indicating a first CORESET associated with the first TRP and a first physical downlink control channel (PDCCH), a second CORESET associated with the second TRP and a second PDCCH, and a link between the first PDCCH and the second PDCCH to enable a PDCCH repetition.

26. The apparatus of claim 25, wherein, to transmit the indication to switch to the sTRP mode, the at least one processor is further configured to:
transmit scheduling DCI that schedules the at least one second transmission, wherein the scheduling DCI comprises a field including the indication to switch the sTRP mode, wherein the indication to switch to the sTRP mode indicates an unsuitable TCI state from the first TCI and the second TCI.

27. The apparatus of claim 26, wherein, to switch to communicate the at least one second transmission with the network node via one of the first TRP or the second TRP in the sTRP mode, the at least one processor is further configured to:
refrain from monitoring the unsuitable TCI state for the at least one second transmission.

28. The apparatus of claim 19, wherein, to transmit the indication to switch to the sTRP mode, the at least one processor is further configured to:
transmit scheduling DCI that schedules the at least one second transmission comprising a physical uplink control channel (PUCCH) resource indicator that indicates one PUCCH repetition, wherein the scheduling DCI comprises the indication to switch to the sTRP mode, wherein the indication comprises at least one of the PUCCH resource indicator, a TCI selection indictor, or a dedicated field of the scheduling DCI that selects a suitable TCI state for the at least one second transmission from the first TCI and the second TCI.

29. A method of wireless communication at a user equipment (UE), comprising:
communicating at least one first transmission with a network node via a first transmission-reception point (TRP) and a second TRP in a multiple TRP (mTRP) mode;
obtaining an indication to switch to a single TRP (sTRP) mode; and
switching to communicate at least one second transmission with the network node via one of the first TRP or the second TRP in the sTRP mode based on the indication to switch to the sTRP mode.

30. A method of wireless communication at a network node, comprising:
communicating at least one first transmission with a user equipment (UE) via a first transmission-reception point (TRP) and a second TRP in a multiple TRP (mTRP) mode;
transmitting an indication to switch to a single TRP (sTRP) mode to the UE; and
switching to communicate at least one second transmission with the UE via one of the first TRP or the second TRP in the sTRP mode based on the indication to switch to the sTRP mode.
